(19) United States
(12) Patent Application Publication
(10) Pub. No.: US 2026/0122691 A1
(43) Pub. Date: Apr. 30, 2026

(54) RANDOM ACCESS METHOD AND APPARATUS IN WIRELESS COMMUNICATION SYSTEM

(71) Applicant: ELECTRONICS AND TELECOMMUNICATIONS RESEARCH INSTITUTE, Daejeon (KR)

(72) Inventors: Chanho YOON, Daejeon (KR); Cheulsoon KIM, Daejeon (KR)

(73) Assignee: ELECTRONICS AND TELECOMMUNICATIONS RESEARCH INSTITUTE, Daejeon (KR)

(21) Appl. No.: 19/371,976

(22) Filed: Oct. 28, 2025

(30) Foreign Application Priority Data
Oct. 30, 2024 (KR) 10-2024-0151321
Oct. 27, 2025 (KR) 10-2025-0156969

(51) Int. Cl. H04W 74/0833; H04L 5/00; H04W 72/0453

(52) U.S. Cl. CPC H04W 74/0833; H04L 5/0055; H04W 72/0453

(57) ABSTRACT

A method of a device may comprise: receiving, from a reader, a Msg0 indicating initiation of a random access procedure; transmitting, to the reader, a Msg1 for random access based on information included in the Msg0 by using a backscattering scheme receiving, from the reader, a plurality of Msg2; based on existence of a first Msg2 among the plurality of Msg2 that responds to the Msg1, transmitting, to the reader, a Msg3 including information of the device based on first information included in the first Msg2 by using the backscattering scheme; and receiving, from the reader, a Msg4 responding to the Msg3.

### CROSS-REFERENCE TO RELATED APPLICATIONS

This application claims priority to Korean Patent Applications No. 10-2024-0151321, filed on Oct. 30, 2024, and No. 10-2025-0156969, filed on Oct. 27, 2025, with the Korean Intellectual Property Office (KIPO), the entire contents of which are hereby incorporated by reference.

### BACKGROUND

### 1. Technical Field

The present disclosure relates to a random access technique in a wireless communication system, and more particularly, to a random access technique in a wireless communication system using an integrated sensing and communication (ISAC) scheme.

### 2. Related Art

The mobile communication system has evolved from fourth generation (4G) long term evolution LTE to fifth generation (5G) new radio NR, and evolution of each generation has progressed with goals exceeding requirements of a previous generation. As one example, in terms of maximum data rate and capacity, 5G NR has a goal of achieving twenty times that of 4G LTE. In order to achieve twenty times that of 4G LTE in terms of maximum data rate and capacity, 5G NR has promoted capacity enhancement of a cellular system by applying utilization of new frequency bands such as a 3.5 GHz center frequency, allocation of wide bandwidth, and massive multiple input and multiple output (MIMO) techniques to which a plurality of antennas, a plurality of transmission and reception radio frequency (RF) chains, and a plurality of spatial layers are applied. Furthermore, 5G NR applies beamforming (BF) in consideration of wide bandwidth and channel characteristics of a 28 GHz millimeter wave (mmWave) band that mainly applies a time division duplexing (TDD) scheme, thereby achieving twenty times that of 4G LTE in terms of maximum data rate and capacity.

Meanwhile, a sixth generation (6G) mobile communication network (or a cellular network) includes achieving a maximum capacity and data rate twenty times higher than that of 5G NR. In addition, a 6G mobile communication network is expected to pursue a convergent tendency of devices such as internet of things (IoT)-based sensors in accordance with a trend of the fourth industrial era, as well as a goal of increasing frequency efficiency pursued in previous generations.

Examples of a 6G mobile communication network include a non-terrestrial network (NTN), an integrated sensing and communication (ISAC) system integrating sensing and communication, and ambient internet of things (AIoT) extending an existing radio frequency identification (RFID) system concept to a utilization domain of IoT.

Although discussions are currently being conducted on AIoT technology, methods for providing a fair channel access opportunity to AIoT devices have not been presented. Accordingly, protocols through which an AIoT device transmits an uplink channel need to be provided.

### SUMMARY

The present disclosure for resolving the above-described problems is directed to providing a method and apparatus of providing protocols for an AIoT device to transmit uplink channels.

A method according to a first exemplary embodiment of the present disclosure, as a method of a device, may comprise: receiving, from a reader, a message 0 (Msg0) indicating initiation of a random access procedure: transmitting, to the reader, a message 1 (Msg1) for random access based on information included in the Msg0 by using a backscattering scheme: receiving, from the reader, a plurality of messages 2 (Msg2); based on existence of a first Msg2 among the plurality of Msg2 that responds to the Msg1, transmitting, to the reader, a message 3 (Msg3) including information of the device based on first information included in the first Msg2 by using the backscattering scheme; and receiving, from the reader, a message 4 (Msg4) responding to the Msg3, wherein the Msg0 includes at least one of information on a counter of at least one of a slot or a frame, information on a ratio of energy harvesting periods (EHPs) within a predetermined time duration, information on a minimum awake duration of the device, command type information, or backward link (BL) occasion resource information.

The Msg0 may be transmitted by being scrambled with a scrambling bit sequence generated based on a forward link (FL) start indicator sequence (SIS).

The Msg1 may be transmitted to the reader in a BL occasion based on the BL occasion resource information included in the Msg0 by using the backscattering scheme, and the Msg1 may be generated using a bit sequence based on a number of a slot or frame in which the Msg1 is transmitted and a value randomly generated by the device.

A second Msg2 among the plurality of Msg2 may include second information for notifying devices that have failed Msg1 transmission, and the second information may include information on a next BL occasion and a maximum back-off window value for Msg1 transmission.

The first information may include at least one of frequency division multiple access (FDMA)-based frequency resource allocation information for transmission of the Msg3, information on a slot or frame for transmission of the Msg3, or information on a modulation order for data included in the Msg3.

The Msg3 may be modulated with a second modulation order higher than a first modulation order used for transmission of the Msg1, based on at least one of an energy harvesting rate of the device or a ratio of EHPs within a predetermined time duration being equal to or greater than a preset first value.

The method may further comprise: transmitting, to the reader, acknowledgement (ACK) information in response to reception of the Msg4 by using the backscattering scheme.

A method of a reader, according to an exemplary embodiment of the present disclosure, may comprise: transmitting, to devices, in a forward link (FL), a message 0 (Msg0) indicating initiation of a random access procedure: receiving, from the devices, a plurality of messages 1 (Msg1) for random access based on information included in the Msg0; generating a plurality of first messages 2 (Msg2) including first information to be transmitted to first devices from which reception of the Msg1 has succeeded, and a second Msg2 including second information to be transmitted to second devices from which reception of the Msg1 has failed: transmitting the plurality of first Msg2 and the second Msg2 to the devices by time-division multiplexing: receiving, from each of one or more of the first devices, a message 3 (Msg3) including information of each of one or more of the first devices based on the first Msg2; and transmitting a message 4 (Msg4) responding to the Msg3 to the one or more of the first devices, wherein the Msg0 includes at least one of information on a counter of at least one of a slot or a frame, information on a ratio of energy harvesting periods (EHPs) within a predetermined time duration, information on a minimum awake duration of the devices, command type information, or backward link (BL) occasion resource information.

The Msg0 may be transmitted by being scrambled with a scrambling bit sequence generated based on an FL start indicator sequence (SIS).

The Msg1 may be generated using a bit sequence based on a number of a slot or frame in which the Msg1 is transmitted and a value randomly generated by the device.

The second information may include information on a next BL occasion and a maximum back-off window value for Msg1 transmission.

The first information may include at least one of frequency division multiple access (FDMA)-based frequency resource allocation information for transmission of the Msg3, information on a slot or frame for transmission of the Msg3, or information on a modulation order for data included in the Msg3.

The Msg3 may be modulated with a second modulation order higher than a first modulation order used for transmission of the Msg1, based on at least one of an energy harvesting rate of the device or a ratio of EHPs within a predetermined time duration being equal to or greater than a preset first value.

The method may further comprise: receiving, from the one or more of the first devices, acknowledgement (ACK) information in response to transmission of the Msg4.

A device according to an exemplary embodiment of the present disclosure may comprise at least one processor, wherein the at least one processor may cause the device to perform: receiving, from a reader, a message 0 (Msg0) indicating initiation of a random access procedure: transmitting, to the reader, a message 1 (Msg1) for random access based on information included in the Msg0 by using a backscattering scheme: receiving, from the reader, a plurality of messages 2 (Msg2); based on existence of a first Msg2 among the plurality of Msg2 that responds to the Msg1, transmitting, to the reader, a message 3 (Msg3) including information of the device based on first information included in the first Msg2 by using the backscattering scheme; and receiving, from the reader, a message 4 (Msg4) responding to the Msg3, wherein the Msg0 includes at least one of information on a counter of at least one of a slot or a frame, information on a ratio of energy harvesting periods (EHPs) within a predetermined time duration, information on a minimum awake duration of the device, command type information, or backward link (BL) occasion resource information.

The Msg0 may be transmitted by being scrambled with a scrambling bit sequence generated based on a forward link (FL) start indicator sequence (SIS).

The Msg1 may be transmitted to the reader in a BL occasion based on the BL occasion resource information included in the Msg0 by using the backscattering scheme, and the Msg1 may be generated using a bit sequence based on a number of a slot or frame in which the Msg1 is transmitted and a value randomly generated by the device.

A second Msg2 among the plurality of Msg2 may include second information for notifying devices that have failed Msg1 transmission, and the second information may include information on a next BL occasion and a maximum back-off window value for Msg1 transmission.

The first information may include at least one of frequency division multiple access (FDMA)-based frequency resource allocation information for transmission of the Msg3, information on a slot or frame for transmission of the Msg3, or information on a modulation order for data included in the Msg3.

The Msg3 may be modulated with a second modulation order higher than a first modulation order used for transmission of the Msg1, based on at least one of an energy harvesting rate of the device or a ratio of EHPs within a predetermined time duration being equal to or greater than a preset first value.

According to exemplary embodiments of the present disclosure, in a wireless communication system using an integrated sensing and communication (ISAC) scheme, a random access method that can be used in integration with channels based on a CP-OFDM system when communicating with IoT devices can be provided. Accordingly, according to the present disclosure, there is an advantage in that an IoT device can communicate with a reader without modification of a cellular system currently using a CP-OFDM scheme. In addition, according to the present disclosure, information enabling the IoT device that has failed in a random access procedure to perform random access again can be provided, and through such information, the IoT device can perform random access without an additional procedure.

Furthermore, there is an advantage in that data transmission efficiency can be improved by configuring the IoT device to set a different modulation order for data transmission according to a distance between the IoT device and the reader, device capability of the IoT device, and a ratio of an energy harvesting period transmitted by the reader.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3A is a conceptual diagram illustrating an overall frame structure of an AIoT system.

FIG. 3B is a conceptual diagram illustrating a case in which a communication period of an AIoT system is composed of an FL period and a BL period.

FIG. 3C is a conceptual diagram illustrating a case in which a communication period of an AIoT system is composed of only an FL period.

FIG. 3D is a conceptual diagram illustrating a case in which a communication period of an AIoT system is composed of only a BL period.

FIG. 4 is a conceptual diagram illustrating a case in which a 5G NR base station generates an AIoT-based signal and transmits the signal during an energy harvesting period.

FIG. 5A is a conceptual diagram illustrating a procedure of processing data transmitted through a PRDSCH in an AIoT system.

FIG. 5B is a conceptual diagram illustrating a process of encoding data transmitted through a PRDSCH in an AIoT system.

FIG. 5C is a conceptual diagram illustrating a case of modulating data transmitted through a PRDSCH using the OOK-1 scheme in an AIoT system.

FIG. 5D is a conceptual diagram illustrating a case of modulating data transmitted through a PRDSCH using the OOK-4 scheme in an AIoT system.

FIG. 6A is a conceptual diagram illustrating a method of generating a CP-OFDM signal using a symmetric duplicate scheme in an AIoT system.

FIG. 6B is a conceptual diagram illustrating an output of an OOK modulation scheme corresponding to an OFDM symbol having a sample length 512 in a 5G NR system.

FIG. 6C is a conceptual diagram illustrating an output of an OOK modulation scheme corresponding to an OFDM symbol having a sample length 1024 in a 5G NR system.

FIG. 7 is a conceptual diagram illustrating a configuration of a CP-OFDM signal transmitted in an FL transmission period of an AIoT system.

FIG. 8 is a conceptual diagram illustrating a configuration of a PRDSB and a configuration of OFDM symbols transmitted in an AIoT system.

FIG. 9A is a timing diagram illustrating operations in some time periods when a RACH procedure is performed between a reader and a device in an AIoT system.

FIG. 9B is a timing diagram illustrating operations in a time period subsequent to FIG. 9A when the RACH procedure is performed between the reader and the device in the AIoT system.

FIG. 9C is a timing diagram illustrating operations in a time period subsequent to FIG. 9B when the RACH procedure is performed between the reader and the device in the AIoT system.

FIG. 10A is a sequence diagram illustrating an operation in which a reader generates Msg0 in an AIoT system.

FIG. 10B is a sequence diagram illustrating an operation in which a device generates and transmits a Msg1 in an AIoT system.

FIG. 11A is a sequence diagram illustrating an operation in which a reader generates and transmits a Msg2 according to a first exemplary embodiment in an AIoT system.

FIG. 11B is a sequence diagram illustrating an operation in which a reader generates and transmits a Msg2 according to a second exemplary embodiment in the AIoT system.

FIG. 12 is a sequence diagram illustrating an operation in which a device generates a PDRSB and a Msg3 and transmits the PDRSB and Msg3 to a reader in an AIoT system.

FIG. 13 is a sequence diagram illustrating an operation in which a reader generates and transmits a Msg4 in an AIoT system.

FIG. 14A is a partial timing diagram illustrating a procedure in which a back-off time is determined according to an energy harvesting rate of a device in an AIoT system.

FIG. 14B is a remaining timing diagram illustrating the procedure in which the back-off time is determined according to the energy harvesting rate of the device in an AIoT system.

FIG. 15 is a conceptual diagram illustrating selection of a frequency resource in which a Msg1 is transmitted according to energy harvesting rate capability of a device.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present disclosure, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like. Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

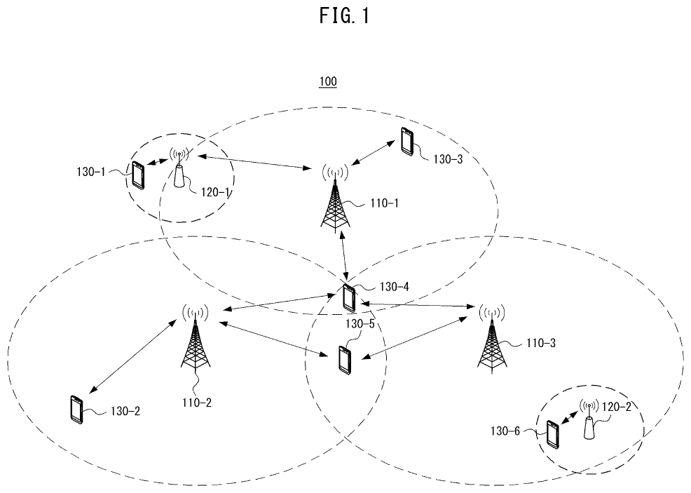

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g. long term evolution (LTE), LTE-advanced (LTE-A)), 5G communication (e.g. new radio (NR)), etc. specified in the 3rd generation partnership project (3GPP) standards. The 4G communication may be performed in frequency bands below 6 GHz, and the 5G communication may be performed in frequency bands above 6 GHz as well as frequency bands below 6 GHz.

For example, in order to perform the 4G communication and 5G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network. When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

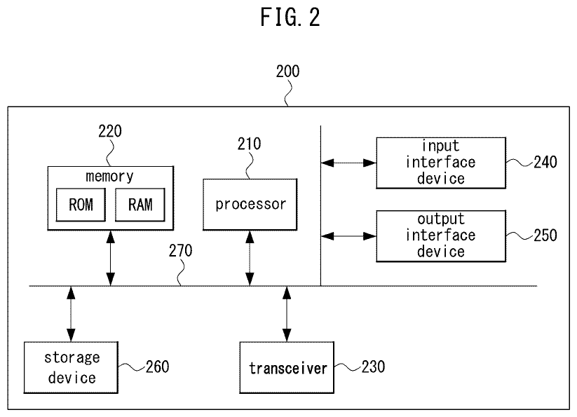

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), gNB, base transceiver station (BTS), radio base station, radio transceiver, access point, access node, road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IoT) device, mounted module/device/terminal, on-board device/terminal, or the like.

Meanwhile, each of the plurality of base stations 110-1, 110-2, 110-3, 120-1, and 120-2 may operate in the same frequency band/or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for configuring and managing radio interfaces in a communication system will be described. Even when a method (e.g. transmission or reception of a signal) performed at a first communication node among communication nodes is described, the corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g. remote radio transmission/reception function, baseband processing function, and the like) of a communication protocol. Alternatively, the remote radio transmission/reception function among all the functions of the communication protocol may be performed by a transmission and reception point (TRP) (e.g. flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

In the present disclosure, a phrase including “when ˜” may be expressed as a phrase including “based on ˜” or a phrase including “in response to ˜”. In other words, a phrase including “when ˜” may be interpreted as being the same as or similar to a phrase including “based on ˜” or a phrase including “in response to ˜”.

Hereinafter, an energy harvesting-based wireless transmission system according to the present disclosure is described.

In the present disclosure, the 3GPP-based system described in FIG. 1 and FIG. 2 may be used as an example. In the following description, a next generation NodeB may be included as a base station in addition to the base stations described in FIG. 1 and FIG. 2. A terminal may refer to a communication device carried or held by a user, and may also be referred to as a user terminal or a wireless device in addition to an MS or a UE described in FIG. 1 and FIG. 2. Hereinafter, in the present disclosure, a device may be referred to as a wireless apparatus that utilizes energy harvesting. In the following description, an uplink may refer to a communication link from a terminal to a base station, and a downlink may refer to a communication link from a base station to a terminal.

Based on 3GPP radio access network specifications, a physical layer as a first layer may provide information transfer services to an upper layer using physical channels. The physical layer may be connected to a medium access control (MAC) layer as an upper layer through transport channels. Data may be transferred between the MAC layer and the physical layer through the transport channels. Data may be delivered through physical channels between a physical layer of a transmitting side and a physical layer of a receiving side. A physical channel may use a time resource and a frequency resource. Specifically, physical channels may be modulated in an orthogonal frequency division multiple access (OFDMA) scheme in the downlink, and may be modulated in a single carrier frequency division multiple access (SC-FDMA) scheme or an OFDMA scheme in the uplink.

In addition, a reader (e.g. a base station or a terminal) may transmit data in the downlink using a modulation scheme other than the OFDMA-based scheme. A device may transmit data using a backscattering-based single carrier modulation scheme rather than the SC-FDMA-based scheme.

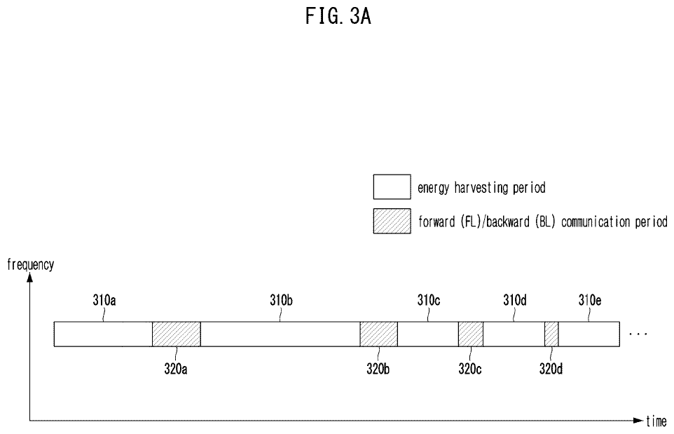

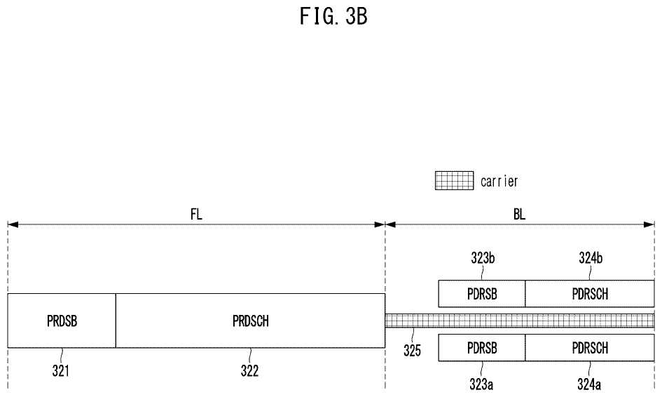

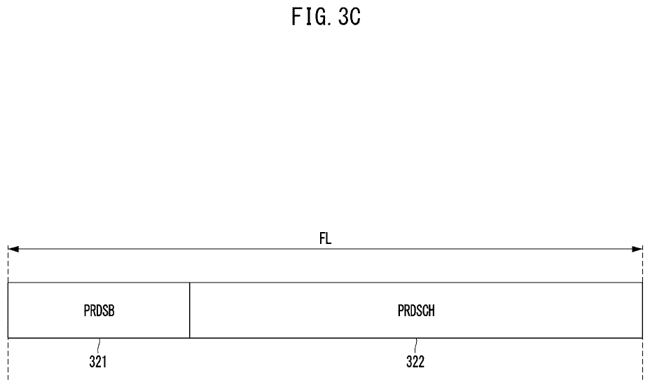

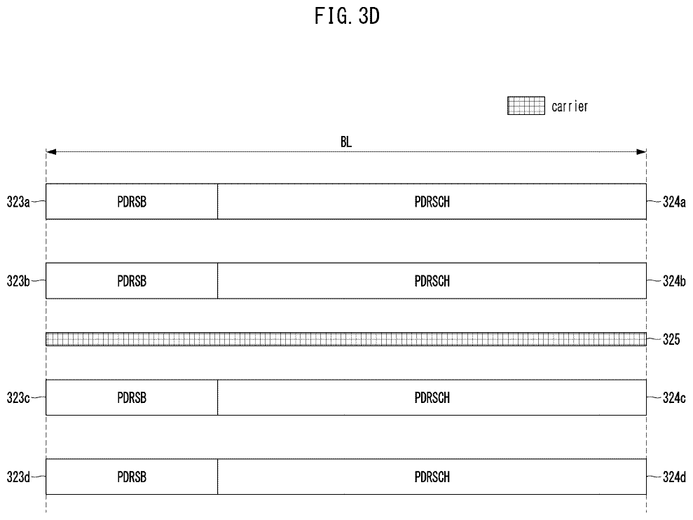

FIG. 3A is a conceptual diagram illustrating an overall frame structure of an AIoT system.

Referring to FIG. 3A, an overall frame structure of an AIoT system may include harvesting periods 310a, 310b, 310c, 310d, and 310e and communication periods 320a, 320b, 320c, and 320d, which are time-division multiplexed on a time axis in a specific frequency band. In other words, in the specific frequency band of the AIoT system, a period may be an energy harvesting period or a communication period depending on time.

As shown in FIG. 3A, the respective energy harvesting periods (EHPs) 310a, 310b, 310c, 310d, and 310e may have different time durations, and the respective communication periods 320a, 320b, 320c, and 320d may also have different time durations. In other words, the EHPs 310a, 310b, 310c, 310d, and 310e may not be operated with a fixed time duration, and the communication periods 320a, 320b, 320c, and 320d may also not be operated with a fixed time duration. In addition, the EHPs 310a, 310b, 310c, 310d, and 310e and the communication periods 320a, 320b, 320c, and 320d may not be operated in a fixed frequency region.

In the EHPs 310a, 310b, 310c, 310d, and 310e, device(s) may receive a signal transmitted from a base station to harvest energy. In addition, as shown in FIG. 3A, the EHPs 310a, 310b, 310c, 310d, and 310e may generally be configured to be longer in time than the communication periods 320a, 320b, 320c, and 320d. For example, the EHPs 310a, 310b, 310c, 310d, and 310e may be ten times or more longer than the communication periods 320a, 320b, 320c, and 320d.

Each of the communication periods 320a, 320b, 320c, and 320d may occur after a corresponding EHP among the EHPs 310a, 310b, 310c, 310d, and 310e. Each of the communication periods 320a, 320b, 320c, and 320d may be divided into a forward link (or forward link communication) period (i.e. FL period) and/or a backward link (or backward link communication) period (i.e. BL period). Each of the communication periods 320a, 320b, 320c, and 320d may be configured with only a forward link (FL) transmission period, only a backward link (BL) transmission period, or a combination of an FL transmission period and a BL transmission period. An FL transmission period may be divided into a physical reader-to-device synchronization block (PRDSB) and a physical reader-to-device shared data channel (PRDSCH). A BL transmission period may be divided into a physical device-to-reader synchronization block (PDRSB) and a physical device-to-reader shared data channel (PDRSCH).

FIG. 3B is a conceptual diagram illustrating a case in which a communication period of an AIoT system is composed of an FL period and a BL period.

Referring to FIG. 3B, an example is shown in which a communication period is composed of an FL transmission period and a BL transmission period. The FL transmission period and the BL transmission period may be configured in different time periods. In the FL transmission period in which a reader performs transmission to device(s), the reader may transmit a PRDSB 321 which is a synchronization block, and then may transmit a PRDSCH 322 which is a data channel. Accordingly, the device(s) may receive the PRDSB 321 to acquire FL synchronization with the reader, and may receive data from the reader through the PRDSCH 322 in the FL period.

Thereafter, in the BL transmission period in which device(s) perform transmission to the reader, device(s) may transmit PDRSB 323a and 323b to the reader, and thereafter the device(s) may transmit PDRSCHs 324a and 324b to the reader. Accordingly, the reader may receive the PDRSB 323a and 323b from device(s) in the BL transmission period, and thereafter may receive data from the device(s) through the PDRSCHs 324a and 324b based on synchronization acquired from the PDRSB 323a and 323b.

In addition, in FIG. 3B, a carrier 325 is illustrated at a center of the PDRSBs 323a and 323b and the PDRSCHs 324a and 324b in the BL transmission period. The carrier 325 of the BL transmission period may be a signal for enabling device(s) to transmit signals based on a backscattering scheme.

FIG. 3C is a conceptual diagram illustrating a case in which a communication period of an AIoT system is composed of only an FL period.

Referring to FIG. 3C, a communication period may be composed of only an FL transmission period. In the FL transmission period in which a reader performs transmission to device(s), the reader may transmit a PRDSB 321, and then may transmit a PRDSCH 322. Accordingly, device(s) may receive the PRDSB 321 to acquire FL synchronization with the reader, and may receive data from the reader through the PRDSCH 322 based on the acquired synchronization in the FL transmission period.

FIG. 3D is a conceptual diagram illustrating a case in which a communication period of an AIoT system is composed of only a BL period.

Referring to FIG. 3D, a communication period may be composed of only a BL transmission period. Unlike the example illustrated in FIG. 3B, in the BL transmission period illustrated in FIG. 3D, device(s) may transmit PDRSB 323a, 323b, 323c, and 323d to the reader, and thereafter the device(s) may transmit PDRSCHs 324a, 324b, 324c, and 324d to the reader. Accordingly, the reader may receive the PDRSB 323a, 323b, 323c, and 323d from the device(s) in the BL transmission period, and thereafter may receive data from the device(s) through the PDRSCHs 324a, 324b, 324c, and 324d based on synchronization acquired from the PDRSB 323a, 323b, 323c, and 323d.

In the BL transmission period of FIG. 3D, a carrier 325 is illustrated at a center of the PDRSBs 323a, 323b, 323c, and 323d and the PDRSCHs 324a, 324b, 324c, and 324d. The case in which a communication period is composed of only a BL transmission period as in FIG. 3D may correspond to a case in which an amount of data transmitted from device(s) to the reader is large or a case in which a large number of devices transmit data to the reader.

The communication period configurations of FIG. 3B, FIG. 3C, and FIG. 3D described above may be applied to each of the communication periods 320a, 320b, 320c, and 320d of FIG. 3A. For ease of understanding, as an example, the first communication period 320a may have a mixed configuration of an FL transmission period and a BL transmission period as illustrated in FIG. 3B, the second communication period 320b may have a configuration composed of only an FL transmission period as illustrated in FIG. 3C, the third communication period 320c may have a configuration composed of only a BL transmission period as illustrated in FIG. 3D, and the fourth communication period 320d may have a configuration composed of only an FL transmission period as illustrated in FIG. 3C. Such descriptions are provided to facilitate understanding of the present disclosure and should not be understood as being limited thereto.

### [1]. Energy Harvesting Signal Configuration Method

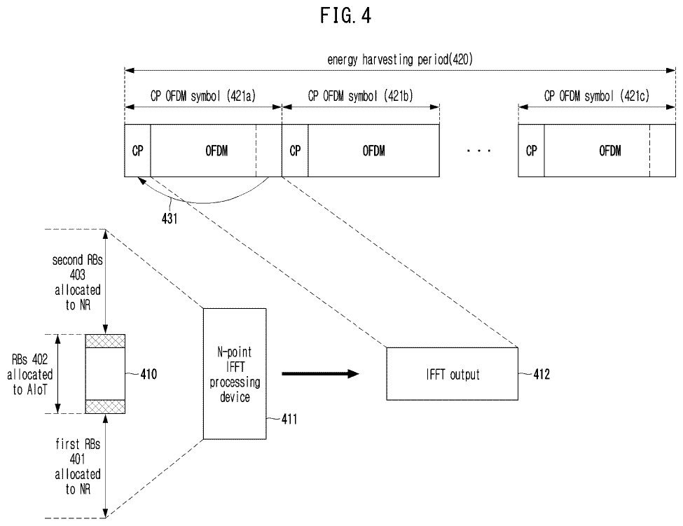

FIG. 4 is a conceptual diagram illustrating a case in which a 5G NR base station generates an AIoT-based signal and transmits the signal during an energy harvesting period.

Prior to referring to FIG. 4, in the present disclosure, an AIoT system may be applied to and operated in 5G NR, which is one of current mobile communication system specifications. For example, a 5G NR base station may operate as a reader of the AIoT system. The 5G NR base station may generate, in an in-band manner, an FL signal and a carrier wave for backscattering within a bandwidth operable in the system.

In FIG. 4, an EHP 420 may correspond to one of the EHPs 310a, 310b, 310c, 310d, and 310e described above with reference to FIG. 3. In other words, the EHP 420 may correspond to a time period. Within the EHP 420, a plurality of cyclic prefix (CP) orthogonal frequency division multiplexing (OFDM) symbols 421a, 421b, . . . , and 421c may be transmitted. The CP OFDM symbol 421a may be generated by copying a predetermined last portion of an OFDM symbol, as indicated by reference numeral 431, and adding the copied portion to the front of the OFDM symbol.

An OFDM symbol without an added CP may be generated by performing inverse fast Fourier transform (IFFT) on a predetermined number of resource blocks (RBs) through an IFFT processing device 411. In other words, an IFFT output 412 generated by the IFFT processing device 411 may be an OFDM symbol.

An input of the IFFT processing device 411 may be a predetermined number of RBs, and in the present disclosure, RBs 402 allocated to AIoT between first RBs 401 allocated to NR and second RBs 403 allocated to NR may be configured for OFDM symbol generation. In addition, among the RBs 402 allocated to AIoT, some RBs adjacent to the first RBs 401 allocated to NR and some RBs adjacent to the second RBs 403 allocated to NR may be used as a guard band. Accordingly, the number of RBs 410 through which an actual signal is transmitted among the RBs 402 allocated to AIoT may be smaller than the number of RBs 402 allocated to AIoT.

As described above, the RBs 402 allocated to AIoT between the first RBs 401 allocated to NR and the second RBs 403 allocated to NR may all be inputs of the IFFT processing device 411 that generates an OFDM signal in the baseband domain. In the IFFT processing device 411, the RBs 402 allocated to AIoT, the first RBs 401 allocated to NR, and the second RBs 403 allocated to NR may be frequency-multiplexed to form an NR downlink signal and an AIoT downlink signal. Accordingly, in the frequency domain, a bandwidth of an EHP may be determined in units of one physical resource block (PRB). In the following description, a signal transmitted for energy harvesting of an AIoT symbol in the EHP is referred to as an energy harvesting preamble or an energy harvesting preamble signal.

An energy harvesting preamble or an energy harvesting preamble signal may be generated by mapping a Zadoff-Chu sequence to subcarriers allocated to AIoT in the frequency domain. When the energy harvesting preamble signal is expressed as a mathematical equation, the energy harvesting preamble signal may be expressed as Equation 1 below.

$${d}_{u} ( n ) = exp ( - j \frac{π un ( n + 1 )}{{N}_{RB}^{BW} {N}_{SC}^{RB}} ) \qquad [ Equation 1 ]$$

$${a}_{k . l} = {d}_{u} ( n ) , n = 0 , 1 , ... , {N}_{RB}^{BW} {N}_{SC}^{RB} - 1 - {N}_{gd}$$

$$k = {K}_{offset}^{AIoT} + {N}_{gd} / 2 + n$$

In Equation 1, u denotes a root index of a Zadoff-Chu sequence dᵤ, and the root index may be mapped to one of the values of

$${N}_{ID}^{( 2 )} ,$$

which correspond to three primary synchronization signal (PSS) sequences used for determining a physical cell identifier (ID) of a 5G NR base station, as shown in Table 1 below.

TABLE 1

| N_{ID}⁽²⁾ | root u |
|---|---|
| 0 | 1 |
| 1 | 6 |
| 2 | 10 |

In Table 1, a case in which the root index u is one of 1, 6, and 10 is exemplified, but this is provided only to facilitate understanding of the present disclosure, and other values may also be used.

$${N}_{R B}^{B W}$$

denotes a number of PRBs of a frequency-axis bandwidth BW occupied by the AIoT system, and a number of subcarriers per PRB may be

$${N}_{S C}^{R B} = 12 .$$

k may denote a subcarrier index in the frequency domain,

$${K}_{offset}^{AIoT}$$

may denote a PKB-level frequency offset indicating a starting position of subcarriers allocated to the AIoT signal within the entire system bandwidth, and N_{gd} may indicate a guard band between the AIoT signal and the NR signal configured by the system.

The Zadoff-Chu sequence having a length

$$z ( {N}_{R B}^{B W} {N}_{SC}^{R B} - {N}_{gd} )$$

generated on the frequency axis may be multiplexed together with the first RBs 401 allocated to NR and the second RBs 403 allocated to NR, and the IFFT output 412 may be generated through the N-point IFFT processing device 411. Here, N may be, for example, one of 2048 and 4096.

As described above, the N-point IFFT output 412 may be a baseband OFDM signal. A CP may be added to the OFDM signal in the manner described above to generate a CP OFDM signal. An energy harvesting preamble signal generated through such a process may be formed to have an OFDM waveform while maintaining orthogonality with the NR signal.

The Zadoff-Chu sequence has constant amplitude zero auto correlation (CAZAC) characteristics in a frequency bandwidth in which a device harvests energy. The CAZAC characteristics include identical amplitudes for all components of a sequence, high power efficiency, low distortion in a power amplifier (PA), strong robustness to interference, and advantages in accurate synchronization and channel estimation. Accordingly, when the Zadoff-Chu sequence is used, energy of the energy harvesting preamble signal may be evenly distributed, and strong characteristics against a frequency selective fading channel may be expected.

### [2]. FL and BL Signal Configuration Method Between a Reader and a Device

As described above with reference to FIG. 3A, the AIoT system may be configured such that EHPs and communication periods are time-division multiplexed. In addition, as described with reference to FIG. 3B to FIG. 3D, each of the communication periods may be composed of an FL transmission period from a reader to device(s) and a BL transmission period from device(s) to a reader.

First, an FL transmission period is described. When an EHP ends, an FL transmission period may start continuously after an end time of the EHP. The FL transmission period may be configured periodically, continuously, or in a semi-persistent manner during periods other than the EHPs.

The FL transmission period may be composed of two periods as illustrated in FIG. 3B or FIG. 3C. In other words, the FL transmission period may be composed of a PRDSB and a PRDSCH. As another example, the FL transmission period may further include an end indicator sequence in addition to the PRDSB and the PRDSCH illustrated in FIG. 3B or FIG. 3C.

The PRDSB described with reference to FIG. 3B and FIG. 3C may be divided into an FL start indicator sequence (SIS) (or FL time synchronization sequence preamble) period for indicating a start point, and a clock synchronization sequence (CSS) period. As described above, the PRDSCH may be a period in which data is transmitted.

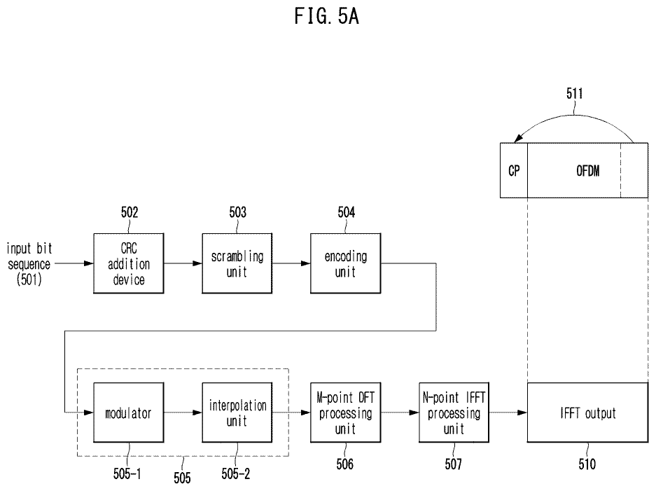

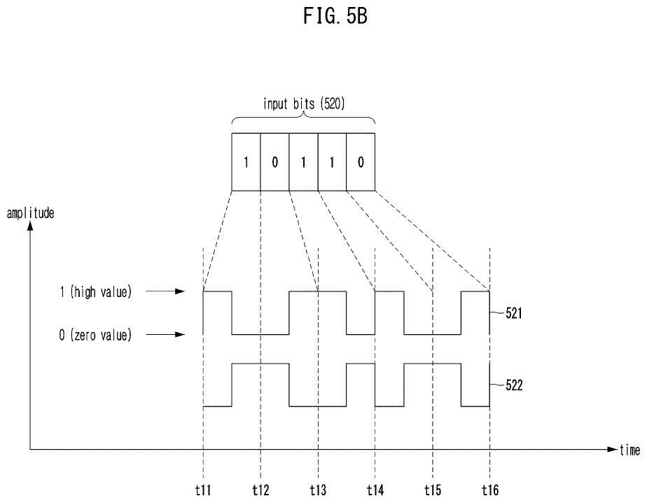

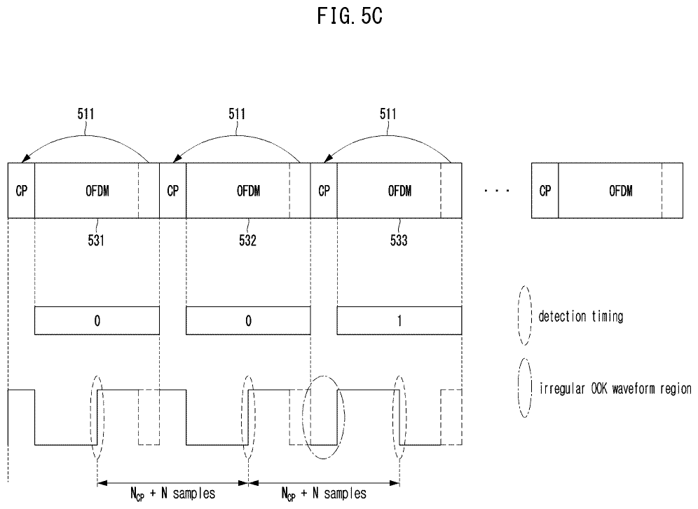

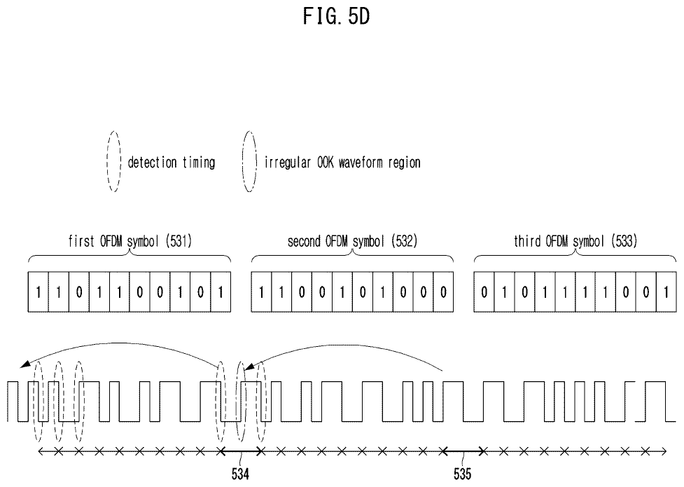

FIG. 5A is a conceptual diagram illustrating a procedure of processing data transmitted through a PRDSCH in an AIoT system.

Referring to FIG. 5A, an input bit sequence 501, which is data to be transmitted by a reader to a device through a PRDSCH, may be input to a cyclic redundancy check (CRC) addition unit 502 that adds a CRC code. The CRC addition unit 502 may add a CRC code to the input bit sequence 501 and output the result. When the reader of the AIoT system is a base station, a length of the CRC code may be, for example, 16 bits.

The output of the CRC addition unit 502 may be input to a scrambling unit 503. The scrambling unit 503 may be a unit that performs scrambling with a Gold sequence initialized by a specific radio network temporary identifier (RNTI). In the present disclosure, the RNTI used in the scrambling unit 503 may be, for example, a cell RNTI (C-RNTI) or a random access RNTI (RA-RNTI), which is used for initialization of the Gold sequence. Accordingly, the scrambling unit 503 may perform scrambling on the output of the CRC addition unit 502 using a Gold sequence initialized by a C-RNTI or an RA-RNTI.

The output of the scrambling unit 503 may be input to an encoding unit 504. In the present disclosure, the encoding unit 504 may be a unit that performs Manchester encoding. The encoding unit 504 may encode each bit input from the scrambling unit 503 in accordance with a synchronization clock.

The signal encoded in the encoding unit 504 may be input to a modulation unit 505. The modulation unit 505 may include a modulator 505-1 and an interpolation unit 505-2. The modulator 505-1 may be a unit for modulating the encoded signal, and the present disclosure assumes a case in which an on-off keying (OOK) modulation scheme is used. The OOK modulation scheme may use one of an OOK-1 modulation scheme and an OOK-4 modulation scheme. The OOK-1 modulation scheme and the OOK-4 modulation scheme are further described below with reference to drawings.

The signal modulated in the modulator 505-1 may be input to an interpolation unit 505-2. The interpolation unit 505-2 may segment the output of the modulator in units of a predetermined size. In other words, the modulation unit 505 may modulate an input signal and then output modulated symbols segmented in units of a predetermined size.

The modulated symbols output from the modulation unit 505 may be input to a discrete Fourier transform (DFT) processing unit 506. The DFT processing unit 506 may convert a time domain signal into a frequency domain signal and output the frequency domain signal. The DFT processing unit 506 may be implemented through an FFT algorithm.

The frequency domain signal output from the DFT processing unit 506 may be input to an N-point IFFT processing unit 507. The IFFT processing unit 507 may process the frequency domain signal such that the frequency domain signal is input to designated subbands or RBs of N points. The IFFT processing unit 507 may have the same configuration as the N-point IFFT processing unit 411 described above with reference to FIG. 4. Accordingly, the IFFT processing unit 507 may map the frequency domain signal to corresponding RBs and may generate an IFFT output 510. The IFFT output 510 may be the same as the IFFT output 412 described above with reference to FIG. 4.

FIG. 5A also exemplifies a case in which the IFFT output forms an OFDM symbol, and a CP OFDM waveform may be generated by copying a last partial region of the OFDM symbol and adding the copied region as a CP to the front end of the OFDM symbol.

A CRC code added in the CRC addition unit 502 is an additional code used to allow a device as a receiving side to detect an error, and the reader (or base station) as a transmitting side may calculate the CRC code using generator polynomials. When the CRC addition unit 502 is implemented, shift registers may be used. When the CRC addition unit 502 is configured with shift registers, an initial seed value to be stored in the shift registers needs to be determined. The initial seed value to be stored in the shift registers may use one of a device-specific RNTI, a cell identifier ID of the base station as the reader, a C-RNTI, an identifier (ID) for broadcast, and a broadcast RNTI value.

A scrambling bit sequence c(n) for performing scrambling in the scrambling unit 503 may be generated as a sum of two m-sequences (generated using shift registers). The scrambling bit sequence c(n) may be defined as Equation 2 below.

$$\begin{matrix}c ( n ) = ( {x}_{1} ( n + {N}_{c} ) + {x}_{2} ( n + {N}_{c} ) ) mod 2 \\ {x}_{1} ( n + 31 ) = ( {x}_{1} ( n + 3 ) + {x}_{1} ( n ) ) mod 2 \\ {x}_{2} ( n + 31 ) = ( {x}_{2} ( n + 3 ) + {x}_{2} ( n + 2 ) + {x}_{2} ( n + 1 ) + {x}_{2} ( n ) ) mod 2\end{matrix} \qquad [ Equation 2 ]$$

In Equation 2, N_{C}=1600, the first m-sequence x₁(·) may be initialized as shown in Equation 3 below, and the second m-sequence x₂(·) may be initialized as shown in Equation 4 below.

$$\begin{matrix}{x}_{1} ( 0 ) = 1 , \\ {x}_{1} ( n ) = 0 , \\ n = 1 , 2 , … , 30\end{matrix} \qquad [ Equation 3 ]$$

$${c}_{init} = {\sum }_{i = 0}^{30} {x}_{2} ( i ) \cdot {2}^{i} \qquad [ Equation 4 ]$$

An initial seed cᵢₙᵢₜ may be defined as shown in Equation 5 below.

$${c}_{init} = {N}_{I D}^{cell} \qquad [ Equation 5 ]$$

$${N}_{I D}^{cell}$$

may be one or 1008 physical cell IDs defined in 5G NR.
[2a]. OOK Modulation Signal Generation Method for an IoT FL Signal Considering CP Generation in an OFDM-Based System

A device may process an FL signal received in an FL transmission period in the time domain. As described above with reference to FIG. 5A, an OFDM-based FL signal may be transmitted as a modulated signal in a form similar to discrete Fourier transform spread orthogonal frequency division multiplexing (DFT-s-OFDM). The device described in the present disclosure may process all data signals and synchronization signals as Manchester-encoded signals (e.g. line-coded signals). Hereinafter, a Manchester encoding process in the encoding unit 504 exemplified in FIG. 5A is described.

FIG. 5B is a conceptual diagram illustrating a process of encoding data transmitted through a PRDSCH in an AIoT system.

As described above with reference to FIG. 5A, data transmitted through a PRDSCH may be encoded by the encoding unit 504. In addition, the encoding unit 504 may be a Manchester encoding unit (or a line coding device). The Manchester encoding unit may operate in an encoding scheme in which each bit is encoded based on a voltage change of a signal. More specifically, the Manchester encoding unit may define an information bit “0” to be transmitted by using an edge changing from a first value to a second value, and may define an information bit “1” to be transmitted by using an edge changing from the second value to the first value. In other words, the Manchester encoding unit may use a differential encoding scheme that detects an energy difference of an envelope. Here, one of the first value and the second value may be a low energy value (e.g. a zero value (or volt)) and the other value may be a high value.

As described above, according to definitions of the first value and the second value, the Manchester encoding unit may encode an information bit to be transmitted in two opposite schemes.

FIG. 5B shows an example of an encoding scheme using the Manchester line coding unit. The Manchester line coding scheme may be a scheme designed such that a signal changes within a period in which each bit is transmitted for easier synchronization. In other words, a change from the first value to the second value or a change from the second value to the first value may occur in the middle of a time period in which a specific bit is transmitted. Also in this case, similarly to the Manchester encoding unit, an information bit to be transmitted may be encoded in two opposite schemes according to the definition of the first value and the second value.

FIG. 5B shows an output 521 according to a first encoding scheme and an output 522 according to a second encoding scheme, where the first encoding scheme defines the first value and the second value differently from the second encoding scheme. In FIG. 5B, for simplification of a drawing and convenience of description, the output 522 of the second encoding scheme is illustrated under the output 521 of the first encoding scheme.

Referring to FIG. 5B, a case in which input bits 520 of the encoding unit 504 are “10110” is exemplified.

The first encoding scheme may be an encoding scheme that defines an information bit “1” as a form changing from a high value to a low value in the middle of an information bit transmission period, and defines an information bit “0” as a form changing from the low value to the high value in the middle of an information bit transmission period.

In contrast, the second encoding scheme may be an encoding scheme that defines an information bit “1” as a form changing from a low value to a high value in the middle of an information bit transmission period, and defines an information bit “0” as a form changing from the high value to the low value in the middle of an information bit transmission period.

In the example of FIG. 5B, when the input bits 520 and the output 521 according to the first encoding scheme are correspondingly examined, the following description applies.

The Manchester line coding unit may encode, because a first input bit among the input bits 520 is “1”, the first input bit such that a signal changes from a high value to a low value in the middle of a period t11 to t12. Because the second input bit is “0”, the Manchester line coding unit may encode the second input bit such that a signal changes from the high value to the low value in the middle of a period t12 to t13. Because the third input bit is “1”, the Manchester line coding unit may encode the third input bit such that a signal changes from the high value to the low value in the middle of a period t13 to t14. Because the fourth input bit is also “1”, the Manchester line coding unit may encode the fourth input bit such that a signal changes from the high value to the low value in the middle of a period t14 to t15. Lastly, because the fifth input bit is “0”, the Manchester line coding unit may encode the fifth input bit such that a signal changes from a low value to a high value in the middle of a period t15 to t16.

In the example of FIG. 5B, correspondence between the output 522 according to the second encoding scheme and the input bits 520 may be identified as being encoded with a waveform opposite to correspondence between the output 521 according to the first encoding scheme and the input bits 520. This is because definitions of the first value and the second value are different.

A data rate may be determined by the OOK-1 modulation scheme described below. According to the OOK-1 modulation scheme, one bit may be transmitted during a time corresponding to one OFDM symbol length. Hereinafter, the OOK modulation scheme is described.

FIG. 5C is a conceptual diagram illustrating a case of modulating data transmitted through a PRDSCH using the OOK-1 scheme in an AIoT system.

As described above with reference to FIG. 4, the IFFT output may be configured as an OFDM symbol, and a CP OFDM symbol may be generated by copying a last partial portion of the OFDM symbol and adding the copied portion to the front of the OFDM symbol.

Referring to FIG. 5C, an operation of generating a CP OFDM symbol through an operation 511 of adding a CP to an OFDM symbol as described above with reference to FIG. 5A is exemplified. A case in which a first OFDM symbol 531, a second OFDM symbol 532, and a third OFDM symbol 533 are sequentially transmitted is exemplified. In addition, IFFT outputs including data values to be transmitted are exemplified under the first OFDM symbol 531, the second OFDM symbol 532, and the third OFDM symbol 533, respectively.

The OOK-1 scheme may refer to a scheme in which one bit is transmitted in one OFDM symbol. In other words, the OOK-1 scheme may refer to a case in which a modulation order M_{O} is 1. In the present disclosure, the modulation order M_{O} may refer to a data rate, and may refer to a number of bits that can be transmitted during one OFDM symbol time period. Accordingly, the OOK-1 modulation scheme may refer to a scheme in which one bit is transmitted during one OFDM symbol time period.

As exemplified in FIG. 5C, the IFFT output exemplified under the first OFDM symbol 531 may correspond to an example in which an information bit “0” is transmitted, and the IFFT output exemplified under the second OFDM symbol 532 may also correspond to an example in which an information bit “0” is transmitted. In addition, the IFFT output exemplified under the third OFDM symbol 533 may correspond to an example in which an information bit “1” is transmitted.

In the present disclosure, a case in which a detection timing for detecting a bit occurs at a middle portion of each of the OFDM symbols 531, 532, and 533 is exemplified, and a region in which an irregular OOK waveform occurs in a CP portion is exemplified together. This may be because the Manchester line coding unit is used as described above. A time interval between adjacent detection timings may be a period in which (N_{CP}+N) samples are transmitted. In other words, the time interval may correspond to a length of a sum of N samples through which actual data are transmitted and N_{CP} which is a CP length.

FIG. 5D is a conceptual diagram illustrating a case of modulating data transmitted through a PRDSCH using the OOK-4 scheme in an AIoT system.

The OOK-4 scheme may refer to a scheme in which a modulation order M_{O} is 10. In other words, the OOK-4 scheme may refer to a case in which a data rate is 10. Accordingly, in the OOK-4 scheme, a number of information bits that can be transmitted in one OFDM symbol may be 10 bits. In FIG. 5D, the first OFDM symbol 531 may correspond to an example in which information bits “1101100101” are transmitted, the second OFDM symbol 532 may correspond to an example in which information bits “1100101000” are transmitted, and the third OFDM symbol 532 may correspond to an example in which information bits “0101111001” are transmitted.

In FIG. 5D, reference numerals 534 and 535 indicate regions in which irregular OOK waveforms exist, and the regions may refer to irregular detection timing periods. Such a phenomenon may occur due to CP addition.

Accordingly, when an FL transmission of the AIoT system is to be integrated into an OFDM-based system, the device as a receiving side needs to determine how to process CPs. Two methods may be considered as a method for processing CPs.

First, a method may be considered in which a device detects a CP period from an FL signal having an OFDM waveform with a CP, and then recognizes only a signal modulated according to the OOK-1 or OOK-4 modulation scheme included in an OFDM symbol period without processing the detected CP.

Second, a method may be considered in which a device integrates a CP period and an OFDM symbol period from an FL signal having an OFDM waveform with a CP and recognizes the integrated periods as a signal modulated according to the OOK-1 or OOK-4 modulation scheme.

For a device not to separately process a CP, ambiguity should not occur in differential decoding. For this purpose, when a reader (e.g., a 5G NR base station) generates an IFFT output of an IFFT processing unit as a continuously generated OOK-1-modulated signal or OOK-4-modulated signal within a CP OFDM signal interval, as illustrated in FIG. 5C or FIG. 5D described above, such ambiguity may be avoided at the device.

The output of the modulation unit 505 (i.e. the input signal of the DFT processing unit 506) may be pre-generated, on a per-OFDM-symbol basis, as an OOK-1 modulated signal considering CP addition or as an OOK-4 modulated signal considering CP addition, as illustrated in FIG. 5C or FIG. 5D, such that a waveform obtained when a CP is added to the generated OFDM symbol is constant. In other words, from a viewpoint of the device, in Manchester line decoding, a timing for signal detection should be constant within a CP OFDM symbol to reduce device decoding implementation complexity. As a specific example in the CP OFDM system, a case as described below may be assumed.

A case is assumed in which a CP length for one CP-OFDM symbol is 144 and a numerology of 2048-point FFT is applied in the NR system. In this case, an available bandwidth for AIoT may be determined, as shown in Equation 6 below, as a product of a number of RBs in the bandwidth and a number of subcarriers included in one RB.

$${N}_{R B}^{B W} {N}_{S C}^{R B} \qquad [ Equation 6 ]$$

A signal modulated in the OOK scheme, hereinafter referred to as an OOK-modulated signal, may be a signal corresponding to the available bandwidth for AIoT of Equation 6. The OOK-modulated signal needs to be converted into a CP OFDM signal after IFFT processing. Accordingly, a length of the CP OFDM signal may be determined, according to the assumption described above, as shown in Equation 7 below.

$$\frac{144 + 2048}{2048} {N}_{R B}^{B W} {N}_{S C}^{R B} \qquad [ Equation 7 ]$$

In this case, the OOK-modulated signal may be a signal modulated according to the OOK-1 scheme or may be a signal modulated according to the OOK-4 scheme. When a CP OFDM symbol length is generalized in consideration of a meaning of Equation 7, the CP OFDM symbol length may be generalized as shown in Equation 8 below.

$$\frac{{N}_{C P} + {N}_{O F D M}}{{N}_{O F D M}} {N}_{R B}^{B W} {N}_{S C}^{R B} \qquad [ Equation 8 ]$$

In Equation 8, N_{OFDM} may denote an FFT size, and N_{CP} may denote a CP length.

Accordingly, the modulation unit 505 described above with reference to FIG. 5A may need to output, by appropriately interpolating, the OOK-modulated signal corresponding to the available bandwidth for AIoT of Equation 6 in consideration of the CP OFDM symbol length such as Equation 7.

As described above with reference to FIG. 5A, the modulation unit 505 is configured with the modulator 505-1 and the interpolation unit 505-2. In other words, the modulator 505-1 may modulate an encoded bit sequence based on the OOK-1 modulation scheme or may modulate an encoded bit sequence based on the OOK-4 modulation scheme. In addition, the interpolation unit 505-2 may appropriately interpolate the OOK-modulated signal and output the OOK-modulated signal in consideration of the CP OFDM symbol length as described above.

The output of the interpolation unit 505-2 may be input to the DFT processing unit 506. Accordingly, a length of a modulated symbol, as defined in Equation 9 below, may be adjusted by the interpolation unit 505-2 to match the available bandwidth for AIoT described above in Equation 6.

$$\frac{{N}_{C P} + {N}_{O F D M}}{{N}_{O F D M}} \qquad [ Equation 9 ]$$

However, as illustrated in FIG. 5C or FIG. 5D, when a portion having a length of N_{CP} at the end of an OFDM symbol is copied and added as a CP to the front of the OFDM symbol, an irregular interval of an OOK-1 waveform inevitably occurs due to the added CP. Nevertheless, when the device accurately knows a timing for differential decoding and sufficient time is given to measure an energy level before and after the timing for differential decoding, an ambiguity problem of differential decoding does not occur in the device.

In contrast, when a high modulation order (e.g. M_{O}=16) is applied to the OOK-4 modulated signal, a length of a Manchester line coded bit representing one bit may become shorter than a CP length. When the length of a Manchester line coded bit becomes shorter than the CP length, the device needs to know, each time, the CP length and the OFDM symbol length that are received. When the length of a Manchester-encoded bit becomes shorter than the CP length as described above, the device needs to track an accurate decoding timing whenever the device decodes each bit, and complexity of the device may increase.

To prevent such a problem, the present disclosure may additionally provide a method of generating a symmetric duplicate signal. When a symmetric duplicate signal is used, a signal may be configured such that a Manchester decoding violation does not occur when the device receives the signal to which a CP is added.

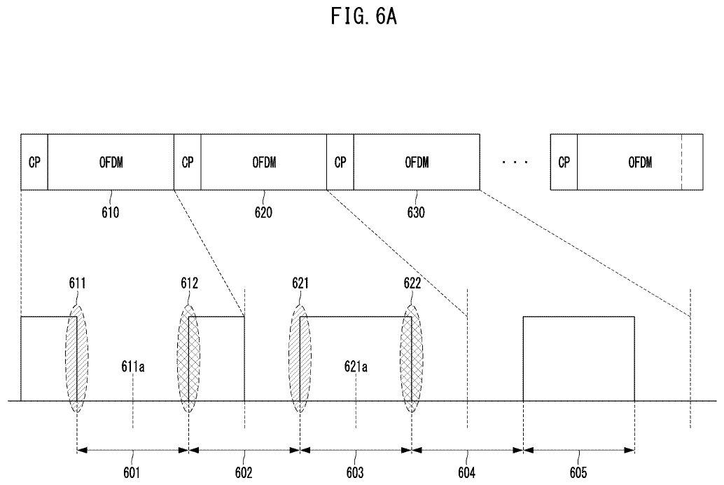

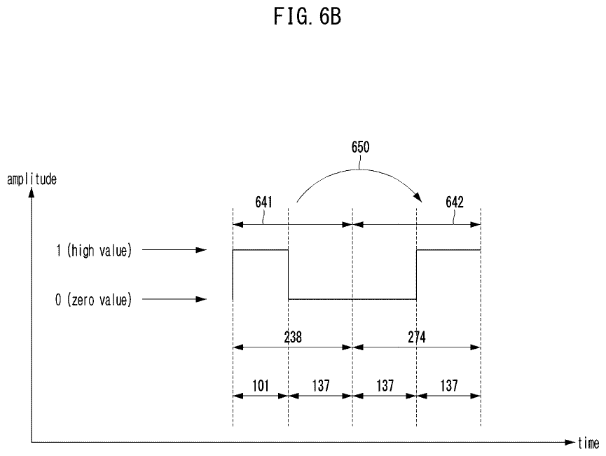

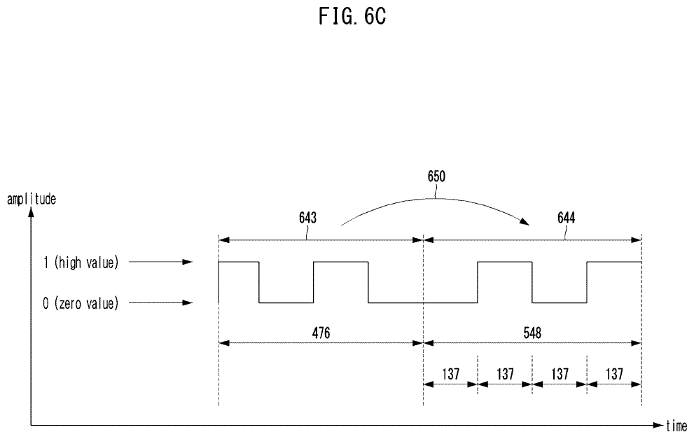

FIG. 6A is a conceptual diagram illustrating a method of generating a CP-OFDM signal using a symmetric duplicate scheme in an AIoT system.

Referring to FIG. 6A, an example in which consecutive CP OFDM symbols 610, 620, 630, and so on are transmitted is illustrated. A method in which each of the first CP OFDM symbol 610, the second CP OFDM symbol 620, and the third CP OFDM symbol 630 among the consecutive CP OFDM symbols 610, 620, 630, and so on is generated in the symmetric duplicate scheme is exemplified below.

The symmetric duplicate scheme may correspond to a scheme in which a signal is configured to be symmetric about a midpoint 611a of samples within a transmission time of one CP OFDM symbol. For example, the first CP OFDM symbol 610 is examined. A Manchester line coded signal may be configured to be symmetric with respect to both sides at a half position 611a within a transmission time in which the first CP OFDM symbol 610 is transmitted. Accordingly, the first CP OFDM symbol 610 may be configured to have a Manchester line coded detection timing 611 in a period before the half position 611a of the first CP OFDM symbol 610. In addition, since a portion after the half position 611a of the first CP OFDM symbol 610 is duplicated in a symmetric manner, a duplicate-reversal detection timing 612 may be obtained.

The second CP OFDM symbol 620 may also be configured to have a Manchester line coded detection timing 621 in a period before the half position 621a of the second CP OFDM symbol 620, and a portion after the half position 621a of the second CP OFDM symbol 620 may be duplicated in a symmetric manner. Accordingly, a duplicate-reversal detection timing 622 may be obtained after the half position 621a of the second CP OFDM symbol 620.

When CP-OFDM symbols are configured and transmitted as illustrated in FIG. 6A, the device may receive with constant timing without a timing change of an OOK square wave interval. In other words, as exemplified in a last stage of FIG. 6A, a time interval 601 between the detection timing 611 of the first CP OFDM symbol 610 and the duplicate-reversal detection timing 612 of the first CP OFDM symbol 610 may be equal to a time interval 602 between the duplicate-reversal detection timing 612 of the first CP OFDM symbol 610 and the detection timing 621 of the second CP OFDM symbol 620. This is because transmission times of the CP OFDM symbols are all identical, and a front portion of a CP OFDM symbol is duplicated and used as a rear portion by dividing the transmission time of the CP OFDM symbol in half.

Accordingly, the time interval 601 may be the same as the time interval 602, and the time interval 602 may be the same as the time interval 603. In other words, the time intervals 601, 602, 603, 604, and 605 may be identical.

However, because a middle portion is configured to be reversed with respect to a transmission time of a CP OFDM symbol, when a symbol modulated according to the OOK-1 scheme is transmitted, reversal directions of a first value and a second value in a first half portion and a second half portion of one CP OFDM symbol may be configured to be opposite to each other, as exemplified in FIG. 6A. In other words, the detection timing 611 of the first CP OFDM symbol 610 may have a form in which a signal changes from the first value (e.g. a high value) to a second value (e.g. the low value), whereas the duplicate-reversal detection timing 612 of the first CP OFDM symbol 610 may have a form in which the signal changes from the second value to the first value.

The device may be configured to perform decoding in a form in which differential Manchester line decoding is applied two times using such a phenomenon.

The OOK-4 modulation scheme proposed in the present disclosure corresponds to a case having a modulation order M_{O}. Accordingly, M_{O} bits may be transmitted within a CP OFDM symbol length transmitted through the OOK-4 modulation scheme.

FIG. 6B is a conceptual diagram illustrating an output of an OOK modulation scheme corresponding to an OFDM symbol having a sample length 512 in a 5G NR system.

Referring to FIG. 6B, a signal output by the OOK modulation scheme may be modulated using a high value (e.g. an information bit “1”) and a low value (e.g. an information bit “0”).

With a need to consider a CP, a length of the OOK-modulated symbol may be configured with a first half portion 641 in which a CP is considered and a second half portion 642 in which a CP is not considered. Because a CP is included in the first half portion, when a sample length is 512, the first half portion 641 may be configured with 238 samples, and the second half portion 642 may be configured with 274 samples. In addition, the 274 samples of the second half portion 642 may be divided in units of 137 samples. In contrast, because the first half portion 641 is configured with 238 samples, a front portion of the first half portion 641 to which a CP is added may be configured with 101 samples, and a remaining portion of the first half portion 641 may be configured with 137 samples.

As described above with reference to FIG. 6A, one OFDM symbol may be configured in the symmetric duplicate scheme within its duration. Accordingly, the first half portion 641 of the OOK-modulated symbol may be mirrored to form the symmetric second half portion 642 of the OOK-modulated symbol.

FIG. 6C is a conceptual diagram illustrating an output of an OOK modulation scheme corresponding to an OFDM symbol having a sample length 1024 in a 5G NR system.

Referring to FIG. 6C, a signal output by the OOK modulation scheme may be modulated using a high value (e.g. an information bit “1”) and a low value (e.g. an information bit “0”).

With a need to consider a CP, a length of the OOK-modulated symbol may be configured with a first half portion 643 in which a CP is considered and a second half portion 644 in which a CP is not considered. Because a CP is included in the first half portion, when a sample length is 1024, the first half portion 643 may be configured with 478 samples, and the second half portion 644 may be configured with 548 samples. In addition, the 548 samples of the second half portion 644 may be divided into four consecutive 137-sample units. In contrast, the first half portion 643 may be configured with 478 samples.

As described above with reference to FIG. 6A, one OFDM symbol may be configured in the symmetric duplicate scheme within its duration. Accordingly, the first half portion 643 of the OOK-modulated symbol may be mirrored to form the symmetric second half portion 644 of the OOK-modulated symbol.

Meanwhile, before the OOK-modulated symbol is input to the IFFT processing unit 507, the OOK-modulated symbol needs to be generated by the DFT processing unit 506 as an OOK-modulated signal having a length corresponding to a number of subcarriers associated with PRB resources allocated to AIoT, the length being defined in Equation 6 described above or calculated as shown in Equation 10 below.

$${N}_{RB}^{B W} {N}_{SC}^{R B} - {N}_{gd} \qquad [ Equation 10 ]$$

To make the length of the OOK-modulated signal be a length of a number of subcarriers associated with PRB resources allocated to AIoT as described above, the interpolation unit 505-2 may interpolate and output the length of the OOK-modulated signal as shown in Equation 6 or Equation 10.

The OOK-modulated signal whose length is interpolated in the interpolation unit 505-2 may be converted, in the DFT processing unit 506, to a frequency domain signal. As described above, the DFT processing unit 506 may be replaced, in configuration, with an FFT processing unit, an FFT processing program or a DFT processing program. The DFT processing unit 506 may perform M-point DFT processing. Here, M may correspond to the length of Equation 6 described above or the length of Equation 10 described above.

The frequency domain signal converted by the DFT processing unit 506 may be input to the IFFT processing unit 507. The IFFT processing unit may map the frequency domain signal to respective subcarriers, convert the signal to a time domain signal, and output the time domain signal. Through such a procedure, the signal to be transmitted in an FL transmission period described above with reference to FIG. 3B or FIG. 3C may be generated. Since the OFDM signal transmitted in an FL transmission period is a CP OFDM signal, a CP may be added to the signal 510 generated based on the descriptions above and the signal 510 to which the CP is added may be transmitted.

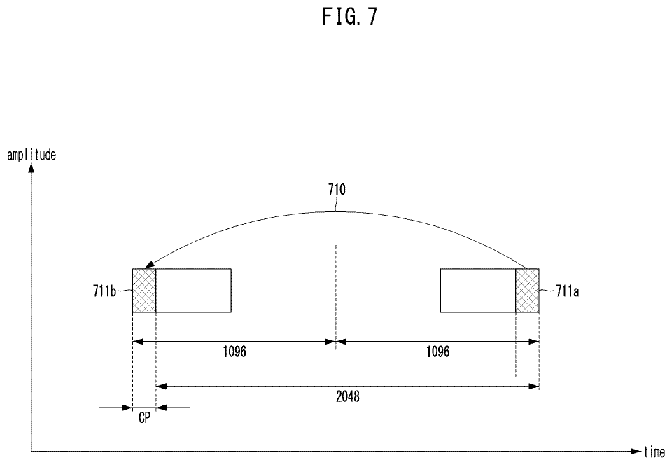

FIG. 7 is a conceptual diagram illustrating a configuration of a CP-OFDM signal transmitted in an FL transmission period of an AIoT system.

Referring to FIG. 7, a case in which a CP length is 144 may be assumed, and a case in which the IFFT processing unit 507 is a 2048-point IFFT processing unit may be assumed. Accordingly, an IFFT output 510, which is mapped to subcarriers associated with PRB resources for AIoT and converted into a time domain signal by the IFFT processing unit 507, may have a length of 2048.

As described above, a CP may have a form in which a last partial portion 711a of the IFFT output 510 having a length of 2048 is copied and added to the front 711b of an OFDM symbol. In FIG. 7, due to addition of the CP, an entire length of a CP OFDM symbol may be 2192, and half of the entire length of the CP-OFDM symbol may be 1096.

[2b]. Method of Configuring an FL Start Indicator and a Clock Synchronization Sequence Using a CP OFDM Symbol Output Based on an OOK-Modulated Signal

As described above with reference to FIG. 3B and FIG. 3C, the reader may transmit a PRDSB and a PRDSCH in an FL transmission period. Hereinafter, a PRDSB is described in detail.

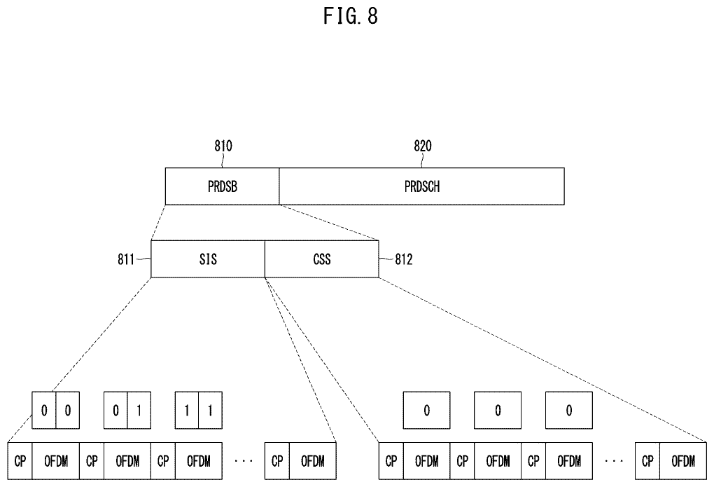

FIG. 8 is a conceptual diagram illustrating a configuration of a PRDSB and a configuration of OFDM symbols transmitted in an AIoT system.

Referring to FIG. 8, a PRDSB 810 and a PRDSCH 820 may be transmitted in an FL transmission period. The PRDSB 810 may be configured with a period in which an FL start indicator sequence (SIS) 811 is transmitted and a period in which a clock synchronization sequence (CSS) 812 is transmitted. In other words, the SIS 811 and the CSS 812 may be transmitted in the PRDSB.

The SIS 811 may be configured with an appropriate sequence for acquiring slot or frame timing synchronization and OFDM symbol timing synchronization of an FL signal transmitted by the reader. The SIS 811 may be configured, for example, with an m-sequence or may be configured with a Gold sequence for which an initial seed cᵢₙᵢₜ in Equation 2 is set to a specific value. When the SIS 811 is configured with a Gold sequence for which the initial seed cᵢₙᵢₜ in Equation 2 is set to a specific value, the SIS 811 may be the sequence c(n) of Equation 2.

Each binary bit of the SIS 811 may be modulated into a mirrored Manchester line code signal through the transmission process as described above with reference to FIG. 5A to FIG. 7. Because the mirrored Manchester line code signal has been described with reference to FIG. 6B and FIG. 6C, redundant description is omitted. The SIS 811 may use the OOK-1 modulation scheme or may use the OOK-4 modulation scheme.

The CSS 812 may be transmitted continuously following the SIS 811 and may be configured in a form of transmitting consecutive identical bits at the bit level. Each binary bit of the CSS 812 may also be modulated into a mirrored Manchester line code signal through the transmission process as described above with reference to FIG. 5A to FIG. 7.

A data component transmitted by the reader in a transmission period of the PRDSCH 820 may be configured with a control channel component and a data channel component. As another example, a data component transmitted by the reader in the transmission period of the PRDSCH 820 may be configured only with a data channel component.

Control channel information transmitted in the transmission period of the PRDSCH 820 may further include a CRC bit sequence scrambled with a 16-bit identifier such as a C-RNTI, an RA-RNTI, or a T_C-RNTI. A method in which the device checks CRC validity may include performing de-scrambling on the CRC code using obtained RNTI information. By checking the CRC code, the device may identify whether control channel information transmitted by the reader is control channel information transmitted to the device itself or control channel information transmitted to another device. In this case, when the device is included in a specific group, the device may check the CRC code using an RNTI allocated to the group, thereby identifying whether control channel information transmitted by the reader is control channel information transmitted to the group to which the device belongs or control channel information transmitted to another group.

The data channel component transmitted by the reader in the PRDSCH 820 may include content similar to a MAC-CE used in an LTE system and/or an NR system, and binary bits input when writing a device. The data channel component transmitted by the reader in the PRDSCH 820 may further include scheduling-related information such as a BL grant. The data channel component transmitted by the reader in the PRDSCH 820 may further include a signal indicating a BL transmission timing based on an environment and a class of the device, a back-off reference counter value, and the like.

### [3]. Method for Configuring a Random Access Procedure for BL Transmission, and for Configuring EHP, FL, and BL Signal Periods

[3a]. Method for Configuring a Random Access Procedure Considering a Device with Limited Energy Storage, and for Configuring EHP, FL, and BL Signal Periods

Slots of an FL transmission period and slots of a BL transmission period of an AIoT system for in-band transmission may be transmitted in accordance with time slot boundaries defined in 5G NR. Slots of an FL transmission period and slots of a BL transmission period may all be configured with the same time duration as time durations of the 5G NR system. Accordingly, a frame unit of an FL transmission period and a BL transmission period may also be assumed to be the same as a time unit defined in 5G NR.

Under the assumptions described above, the AIoT system assumes that a transmission scheme of a random access channel (RACH) is a slotted ALOHA scheme. As described above with reference to FIG. 8, an FL transmission period may be configured with the PRDSB 810 and the PRDSCH 820, and the PRDSB 810 may be configured with the SIS 811 and the CSS 812. Because the SIS 811 is configured with a sequence for acquiring slot or frame timing and OFDM symbol timing of an FL signal, the device may acquire time synchronization with the reader (e.g. base station) by receiving the SIS 811 included in the PRDSB 810 in the FL transmission period.

Accordingly, the device may satisfy an existing condition for using the slotted ALOHA scheme as a RACH transmission scheme. However, the device of the AIoT system fundamentally operates by harvesting energy, and it is difficult to define when the device needs to operate in the RACH transmission scheme. Therefore, in the present disclosure, an operation may be considered in which the reader provides a wake-up signal to the device to allow the device to initiate a BL transmission operation.

In this case, a case in which the device receives a signal from the reader and performs BL transmission in accordance with acquired FL synchronization is assumed. The reader may additionally provide a frame number to the device. For example, when a frame number is configured with 10 bits, frame indexes may be assigned with frame numbers from 0 to 1023.

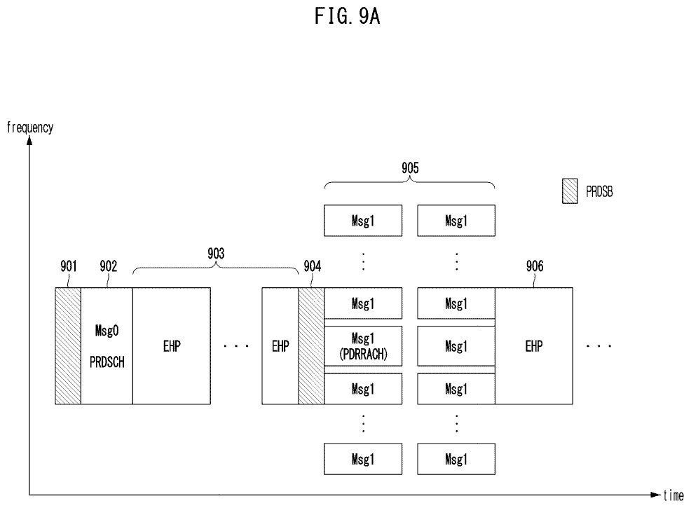

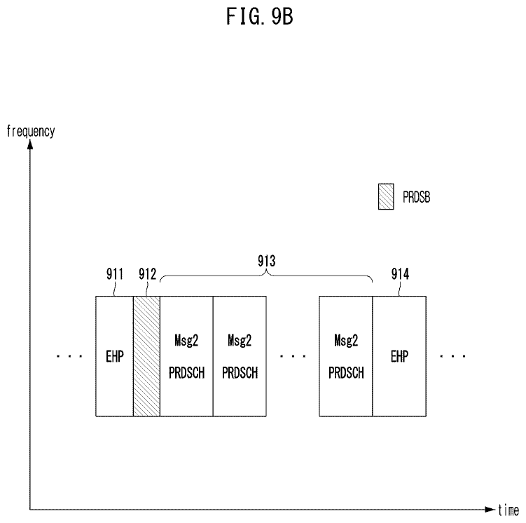

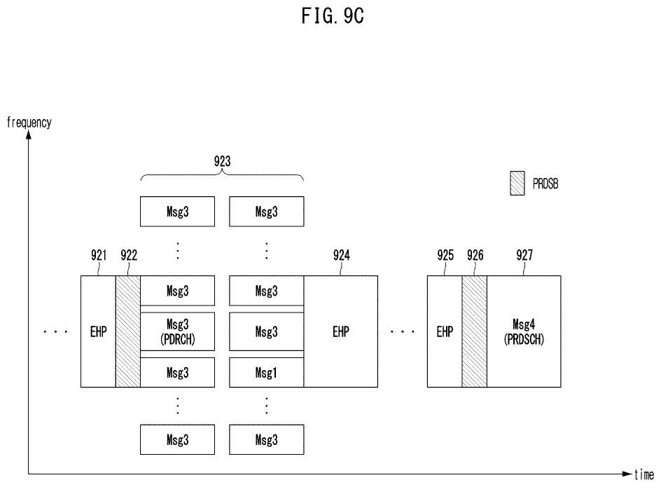

FIG. 9A is a timing diagram illustrating operations in some time periods when a RACH procedure is performed between a reader and a device in an AIoT system, FIG. 9B is a timing diagram illustrating operations in a time period subsequent to FIG. 9A when the RACH procedure is performed between the reader and the device in the AIoT system, and FIG. 9C is a timing diagram illustrating operations in a time period subsequent to FIG. 9B when the RACH procedure is performed between the reader and the device in the AIoT system.

Prior to referring to FIG. 9A, a case is assumed in which a BL transmission is initiated by a request of the reader. In other words, a case is assumed in which the reader first performs a BL request and the device performs a BL operation through a RACH procedure in response thereto. Accordingly, when a process in which the reader transmits the BL request is included, the RACH procedure may be configured with five steps.

Referring to FIG. 9A, the reader (e.g. base station) may transmit a PRDSB 901 in an FL transmission period. As described above, the PRDSB 901 may include an SIS and a CSS. Accordingly, the device may receive the SIS and the CSS included in the PRDSB 901 in the FL transmission period. The device may be previously aware of information on a time at which the PRDSB 901 is transmitted. Accordingly, the device in a fully charged state may receive the PRDSB 901 at the reception time of the PRDSB 901. The device may acquire FL synchronization by receiving the PRDSB 901. In addition, the device may acquire slot or frame timing and OFDM symbol timing of an FL signal described above from the PRDSB 901 transmitted by the reader.

When the device in a fully charged state is in a power-off state, the device may wake up at the reception time of the PRDSB 901 and receive the PRDSB 901.

The reader may transmit the PRDSCH 902 in the FL transmission period. The reader may transmit a Msg0 (message 0) through the PRDSCH 902. The Msg0 may correspond to a message by which the reader requests information on the device from the device. Accordingly, the Msg0 may be understood as an FL inventory and/or inquiry command, and the Msg0 may be a message requesting a device identifier (ID) of the device and data held by the device to be transmitted in a BL transmission period. In another example, the Msg0 may be a message by which the reader indicates execution of a random access procedure to the device.

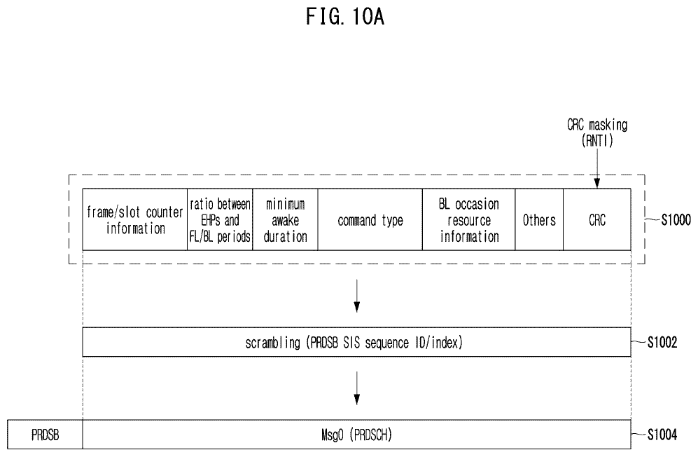

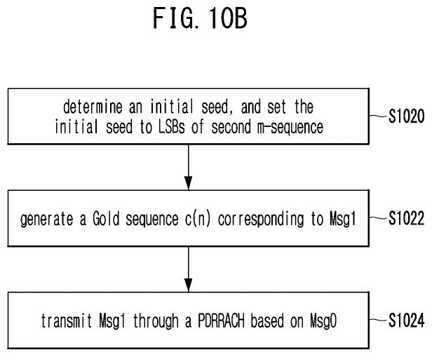

The Msg0 may be a broadcast signal or a multicast signal requesting each of a plurality of devices to transmit data held by each device in a BL transmission period as described above. In another example, the Msg0 may be a signal requesting a device, in a device-specific manner, to transmit data held by the device in a BL transmission period. Hereinafter, for convenience of description, a case is assumed in which the Msg0 is a broadcast signal transmitted to a plurality of devices. An operation in which the reader generates the Msg0 is described with reference to FIG. 10A.

FIG. 10A is a sequence diagram illustrating an operation in which a reader generates Msg0 in an AIoT system.

In step S1000, the reader may configure information to be included in Msg0. The Msg0 may include one or more of the following information.
1) One or more of slot counter information or frame counter information
2) Information on a ratio between EHPs and FL/BL periods
3) Minimum awake duration information
4) Command type information
5) BL occasion resource information

The information to be included in Msg0 may include, for example, one or more of slot counter information or frame counter information.

The Msg0 may include information on a ratio between EHPs and FL/BL periods. The ratio between EHPs and FL/BL periods may be a temporal ratio in units of a frame unit, and may be configured with predetermined bits (e.g. TR bits). For example, to notify the device of one of predetermined ratios, when the ratio between EHPs and FL/BL periods is 10:1, index 0 may be indicated, when the ratio between EHPs and FL/BL periods is 20:1, index 1 may be indicated, and when the ratio between EHPs and FL/BL periods is 50:1, index 2 may be indicated.

The information on the ratio between EHPs and FL/BL periods may be information required for charging because the device of the AIoT system harvests ambient energy with low charging efficiency. In other words, the device may periodically perform charging in EHPs based on the ratio between EHPs and FL/BL periods.

The information on the ratio between EHPs and FL/BL transmission periods may indicate a time ratio allocated to EHPs within a specific time period (e.g. a period from Msg0 transmission to next Msg0 transmission).

The Msg0 may include information on a minimum awake duration. The minimum awake duration may indicate a minimum duration during which the device needs to stay awake in an FL transmission period to acquire time synchronization and to monitor Msg0 when the device is charged to have operable power. The device may monitor an FL based on the minimum awake duration and may re-enter a charging mode when operation is not required. In addition, each device may store information on a default minimum awake duration at a manufacturing stage. When a change of such a value is required, the reader may indicate updating of the minimum awake duration of the device using information on the updated minimum awake duration.

For example, when the default minimum awake duration set in the device is 10 ms, the reader may, when necessary, set the minimum awake duration to 20 ms and indicate device(s) to update the minimum awake duration. When the minimum awake duration is updated by Msg (including information on the minimum awake duration, the device may have an FL signal detection duration of 20 ms until the indication to update the minimum awake duration is provided again.

The Msg0 may include command type information. The command type information may be information for notifying the device whether the reader performs an inquiry for an inventory of the device, whether a command indicating writing is provided to a specific device, or whether another purpose command is provided.

The Msg0 may include BL occasion resource information. The BL occasion resource information may be information for notifying the device of frame(s), slot(s), and/or a modulation order selection range in which transmission of Msg1 (message 1) is possible. The modulation order selection range may be used when frequency division multiple access (FDMA) is supported in BL.

In addition, when other necessary information exists, the Msg0 may further include the necessary information. As other information included in the Msg0, a maximum window value may be further included. The maximum window value may, depending on a case, be included in the BL occasion resource information.

In addition, the Msg0 may further include a CRC code for error detection at the device. The CRC code may be masked or not masked with a specific RNTI depending on a characteristic of the Msg0. For example, when the Msg0 is broadcast to all devices communicating with the reader, masking may not be performed. In contrast, when the Msg0 is transmitted for a specific purpose, a CRC masked with an RNTI corresponding to the purpose, for example a C-RNTI, may be added.

In step S1002, the reader may scramble the Msg0 configured to include the information described above and the CRC code. In this case, a scrambling bit sequence c(n) may be generated as shown in Equation 2 using a SIS sequence ID or a SIS sequence index as an initial seed. The reader may scramble the Msg0 using the scrambling bit sequence c(n).

In step S1004, the reader may transmit the PRDSB first and then transmit Msg0 through the PRDSCH. Accordingly, the device may receive the Msg0 transmitted from the reader through the PRDSCH in step S1004.

Referring again to FIG. 9A, the reader may generate Msg0 in the manner described with reference to FIG. 10A and transmit the Msg0 to device(s) through the PRDSCH, and then transmit an EHP 903. After transmitting the EHP 903, the reader may transmit or broadcast the PRDSB 904 to device(s) in order to provide a time reference.

A device may harvest energy by receiving the EHP 903. The device may receive the PRDSB 904 transmitted by the reader based on energy obtained through reception of the EHP 903. The device may acquire or re-acquire synchronization for an FL transmission with the reader based on the received PRDSB 904.

Each device that receives the Msg0 may generate a Msg1 based on the received Msg0. The Msg1 may be generated based on a Gold sequence. Each device that receives the Msg0 may transmit the Msg1 to the reader in a Msg1 transmission period 905 through a PDRRACH based on the BL occasion resource information of Msg0. As assumed above, the device may transmit the Msg1 using a backscattering scheme when transmitting the Msg1. Hereinafter, a procedure in which the device generates the Msg1 and transmits the Msg1 to the reader is described with reference to FIG. 10B.

FIG. 10B is a sequence diagram illustrating an operation in which a device generates and transmits a Msg1 in an AIoT system.

In step S1020, a case is assumed in which the sequence c(n) described in Equation 2 is used as a sequence of Msg1. The device may determine an initial seed cᵢₙᵢₜ in order to generate a sequence of Msg1. The initial seed cᵢₙᵢₜ may be determined by a combination of a slot number and/or a frame number of Msg0 and a sequence of a predetermined number N_{RA} of bits generated randomly by the device for a random access procedure. In other words, the initial seed cᵢₙᵢₜ may be determined by a bit sequence of {slot or frame counter, N_{RA}}.

For example, when a length of the slot number and/or the frame number is 11 bits, N_{RA} bits generated by the device may be 5 bits. In this case, a sequence of N_{RA} bits having a value of 0 (e.g. a bit sequence of “00000”) may be excluded. The initial seed cᵢₙᵢₜ generated in this manner may have a length of 16 bits and may be an RA-RNTI.

When the initial seed is determined, the device may generate a sequence by filling the determined initial seed into the least significant bits (LSBs) of the second sequence x₂(·) described in Equation 2. The filling of the determined initial seed into the LSBs of the second m-sequence x₂(·) may physically mean setting values in LSBs of shift registers that generate the second m-sequence x₂(·).

In step S1022, the device may generate a Gold sequence c(n) corresponding to Msg1 by using Equation 2.

In step S1024, the device may transmit the Msg1 to the reader through a PDRRACH based on the Msg0. As described above, the Msg0 may include the BL occasion resource information. The BL occasion resource information may include a frame, a slot time, and/or a modulation order selection range in which transmission of Msg1 is possible. Therefore, the device may determine a slot in a Msg1 transmission period 905 based on the frame and the slot time in which transmission of Msg1 is possible. In addition, the device may determine a specific modulation order based on the modulation order range included in the BL occasion resource information. The device may transmit the Msg1 to the reader by using a backscattering scheme based on the slot and the modulation order determined in the Msg1 transmission period 905.

The reader may attempt detection of Msg1 from device(s) in the Msg1 transmission period 905. The number of possible cases of Msg1 that can be transmitted by the device may be 2^{N}^{_{RA}}. In addition, the device may transmit Msg1 based on a slot or frame counter bit provided in the Msg0 received from the reader. Therefore, the reader may attempt Gold sequence detection by using a combination of the number of possible cases of Msg1 that can be transmitted in the Msg1 transmission period 905 and the slot or frame counter bit provided in the Msg0.

The reader may identify Msg1 received in the Msg1 transmission period 905. In other words, when a Gold sequence is detected in the Msg1 transmission period 905, the reader may identify a Gold sequence generated by using a corresponding RA-RNTI. By identifying the Gold sequence, the reader may identify a device that transmitted Msg1.

With reference to FIG. 9A and FIG. 9B consecutive to FIG. 9A, a five-step RACH procedure is continuously described.

First, referring to FIG. 9A, the reader may transmit an EHP 906 after the Msg1 transmission period 905. Referring to FIG. 9B, the reader may transmit an EHP 911. After transmitting the EHP 911, the reader may transmit or broadcast a PRDSB 912 to device(s) in order to provide a time reference to the device(s).

A device may harvest energy by receiving the EHP 911. The device may receive the PRDSB 912 transmitted by the reader by using energy obtained through reception of the EHP 911. The device may acquire synchronization with the reader for FL transmission or may perform re-synchronization based on the received PRDSB 912.

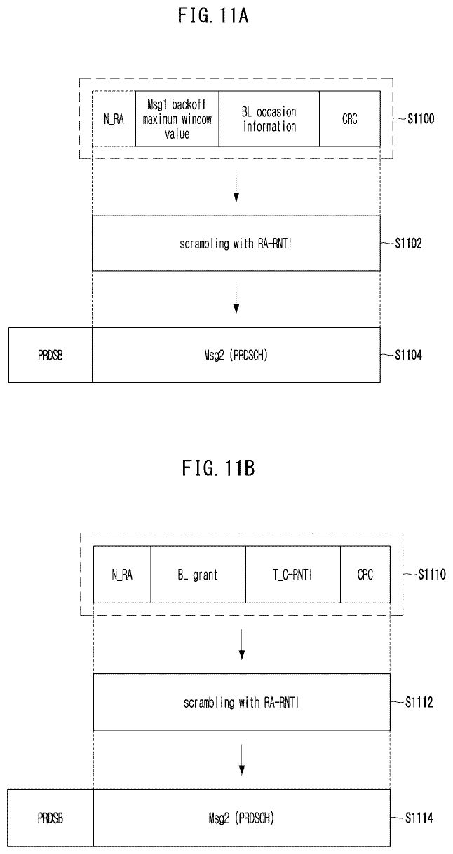

The reader may generate a Msg2 (message 2) to be transmitted to device(s) that transmitted Msg1. The Msg2 may be a random access response (RAR) message. The reader may transmit the Msg2 to device(s) from which the reader has successfully received Msg1 in a Msg2 transmission period 913. Hereinafter, a procedure for generating and transmitting Msg2 by the reader is described with reference to FIG. 11A and FIG. 11B.

FIG. 11A is a sequence diagram illustrating an operation in which a reader generates and transmits a Msg2 according to a first exemplary embodiment in an AIoT system.

In step S1100, the reader may configure information on the number N_{RA} of RA bits, a maximum back-off window value of Msg1, and BL occasion information together with a CRC code. The number N_{RA} of RA bits may be information indicating that N_{RA} is composed of five-bit zero values “00000”. Alternatively, the number N_{RA} of RA bits may be a value known in advance between the reader and the device. Therefore, the number N_{RA} of RA bits may be omitted. It should be noted that, in FIG. 11A, the number N_{RA} of RA bits is indicated by a dotted line to show that the number N_{RA} of RA bits may be omitted.

The maximum back-off window value for Msg1 may be information for notifying device(s), which have transmitted Msg1 and for which the reader has received Msg1 but the device(s) have failed to receive Msg2 from the reader, of a maximum window value during which back-off is to be performed. The BL occasion information may also be information for informing a next BL occasion, and, as described above, may be information for informing the device(s) of a frame, a slot time, and/or a modulation order selection range in which transmission of Msg1 is possible.

As described above, the Msg2 transmitted in FIG. 11A may be Msg2 provided to a device that transmitted Msg1 but did not receive Msg2.

In step S1102, the reader may scramble a bit sequence of Msg2 generated in step S1100 using a scrambling sequence c(n). In this case, the scrambling sequence c(n) may be generated using an RA-RNTI as an initial value. More specifically, the RA-RNTI may be derived by combining one of a slot counter or a frame counter provided in Msg0 with N_{RA} (e.g. {slot counter/frame counter, N_{RA}}). In other words, when generating the scrambling sequence c(n) described in Equation 2, the RA-RNTI is used as an initial value, and Msg2 may be scrambled using the scrambling sequence c(n) generated in this manner.

In step S1104, as described above, after transmitting the PRDSB 912, the reader may continuously transmit the scrambled Msg2 to device(s) through a PRDSCH in the Msg2 transmission period 913. Since the RACH procedure is performed in the slotted ALOHA scheme according to the method described above, when two or more devices transmit Msg1 through the same resource and a collision occurs, at least some of the devices may fail to receive Msg2, and the Msg2 may be a message transmitted in response to such a collision situation.

FIG. 11B is a sequence diagram illustrating an operation in which a reader generates and transmits a Msg2 according to a second exemplary embodiment in the AIoT system.

In step S1110, the reader may configure information on the number N_{RA} of RA bits, BL grant, and a TC-RNTI together with a CRC code. The number N_{RA} of RA bits may be information indicating that N_{RA} is composed of five-bit zero values “00000”.

The BL grant may be information for granting a BL transmission to a specific device. In other words, the BL grant may be information for permitting transmission of a message 3 (Msg3) by a specific device in a BL transmission period. The BL grant may include FDMA-based frequency resource allocation information for transmission of Msg3. The BL grant may include information on a slot or frame for transmission of Msg3. In addition, the BL grant may further include information on a modulation order.

Transmission of the BL grant to a specific device may mean that the specific device transmitted Msg1, the reader successfully received Msg1 transmitted by the specific device, and a resource for permitting a BL transmission by the specific device exists in BL.

As described above, Msg2 transmitted in FIG. 11B may be for a case of permitting transmission of Msg3 to a device that transmitted Msg1. In other words, transmission of Msg2 may correspond to a case in which the reader successfully received Msg1 transmitted by the device.

In step S1112, the reader may scramble a bit sequence of Msg2 generated in step S1110 using a scrambling sequence c(n). In this case, the scrambling sequence c(n) may be generated using an RA-RNTI as an initial value. More specifically, the RA-RNTI may be derived by combining one of a slot counter or a frame counter provided in Msg0 with N_{RA} (e.g. {slot counter/frame counter, N_{RA}}). In other words, when generating the scrambling sequence c(n) described in Equation 2, the RA-RNTI is used as an initial value, and Msg2 may be scrambled using the scrambling sequence c(n) generated in this manner.

In step S1114, as described above, after transmitting the PRDSB 912, the reader may continuously transmit the scrambled Msg2 to device(s) through a PRDSCH.

Referring again to FIG. 9B, a plurality of Msg2 may be transmitted in the Msg2 transmission period 913. In the Msg2 transmission period, Msg2(s) transmitted by the reader to device(s) from which Msg1 has been successfully received as described in FIG. 11B may be transmitted by being time-multiplexed with Msg(s) transmitted by the reader to device(s) from which the reader fails to receive Msg1 as described in FIG. 11A.

Therefore, device(s) that transmitted Msg1 may receive Msg2 from the reader. All device(s) that transmitted Msg1 may need to receive Msg2 described in FIG. 11A. However, device(s) that receive Msg2 described in FIG. 11B may ignore Msg2 described in FIG. 11A.

After transmitting Msg2(s) in the Msg2 transmission period 913, the reader may transmit an EHP 914. Hereinafter, with reference to FIG. 9C consecutive to FIG. 9B, the five-step RACH procedure is continuously described.

Referring to FIG. 9C, the reader may transmit an EHP 921. After transmitting the EHP 921, the reader may transmit or broadcast a PRDSB 922 to device(s) in order to provide a time reference to the device(s).

A device may harvest energy by receiving the EHP 921. The device may receive the PRDSB 922 transmitted by the reader by using energy obtained through reception of the EHP 921. The device may acquire synchronization with the reader for FL transmission or may perform re-synchronization based on the received PRDSB 922.

Each device that receives the Msg2 may generate a Msg3 based on the Msg2 received from the reader. Each device may transmit the generated Msg3 to the reader in a Msg3 transmission period 923. In this case, a slot or frame of the Msg3 transmission period 923 may be composed of a PDRSB through which the device transmits a synchronization signal to the reader and a PDRCH through which the device transmits data to the reader. Therefore, the device may transmit the PDRSB in the Msg3 transmission period 923 and may transmit the Msg3 generated by the device to the reader at a continuous time.

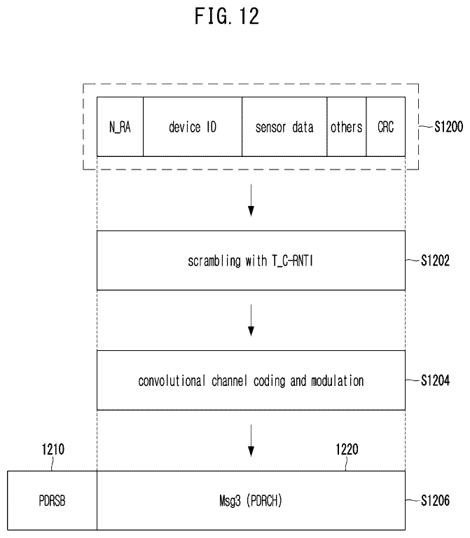

Accordingly, the reader may receive the PDRSB and the Msg3 generated by the device(s) from the device(s) in the Msg3 transmission period 923. Hereinafter, with reference to FIG. 12, a procedure in which the device generates the Msg3 and transmits the PDRSB and Msg3 to the reader is described in detail.

FIG. 12 is a sequence diagram illustrating an operation in which a device generates a PDRSB and a Msg3 and transmits the PDRSB and Msg3 to a reader in an AIoT system.

In step S1200, the device may configure a Msg3 with information to be transmitted to the reader. The information included in the Msg3 may include information on the number N_{RA} of RA bits generated by the device in the Msg1, a device identifier, data to be provided to the reader, and other information. The data to be provided to the reader may be, for example, sensor data. The information included in the Msg3 may further include a CRC code for error detection. Since sensor data is included in the Msg3, data to be transmitted by the device to the reader may be understood to be transmitted through the Msg3.

In step S1202, the device may scramble the information included in Msg3, that is, a data bit stream, by using the T_C-RNTI provided in the Msg2.

In step S1204, the device may perform channel coding on the scrambled data bit stream by using a convolutional channel encoder. In addition, the device may modulate the channel-coded symbols. A modulation scheme of the device may be, for example, a Binary Phase Shift Keying (BPSK) modulation scheme. The BPSK modulation scheme is used as an example in the present disclosure in consideration of implementation complexity of the device. If complexity and power efficiency of the device can be further improved, a modulation scheme of a higher order than the BPSK modulation scheme may be used.

In step S1206, the device may first transmit a PDRSB 1210, which is a synchronization block, to the reader, and may subsequently transmit the Msg3 1220 to the reader through a PDRCH. In this case, the PDRSB 1210 and Msg3 transmitted through the PDRCH may also be transmitted to the reader by using a backscattering scheme.

As exemplified in FIG. 12, the Msg3 1220 transmitted through the PDRCH may be transmitted by convolutional channel coding, unlike the PRDSCH described above. In other words, it should be noted that, unlike the PRDSCH through which data is transmitted in an uncoded state, the PDRCH transmits convolutionally channel-coded data.

Through the procedure described above, the device may transmit the Msg3 to the reader in a Msg3 transmission period 923. Referring again to FIG. 9C, device(s) may transmit Msg3 through the PDRCH. It should be noted that FIG. 9C does not illustrate the PDRSB described in FIG. 12. In FIG. 9C, transmission of the PDRSB is not illustrated in order to avoid complexity of the drawing.

When device(s) transmit the PDRSB and Msg3 through operations as described in FIG. 12, the reader may receive the PDRSB and Msg3 from the device(s). The reader may acquire BL synchronization between the device and the reader through the PDRSB and may acquire sensor data transmitted by the device from Msg3.

After receiving the PDRSB and Msg3, the reader may transmit EHP 924, . . . , and 925 to the device. Accordingly, device(s) may harvest energy from the EHP 924, . . . , and 925 transmitted by the reader. Thereafter, the reader may transmit a PRDSB 925. The device may receive the PRDSB 926 transmitted by the reader based on energy obtained through reception of the EHP 924, . . . , and 925. The device may acquire synchronization with the reader for FL transmission or may perform re-synchronization based on the received PRDSB 926.

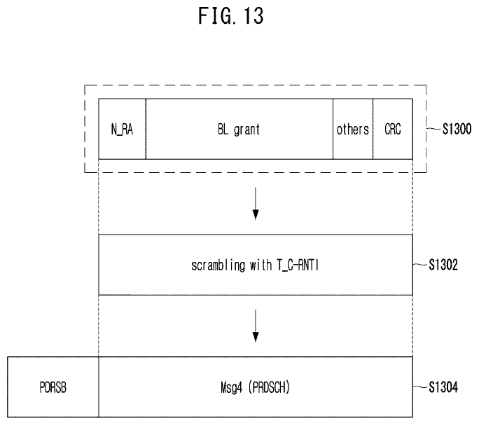

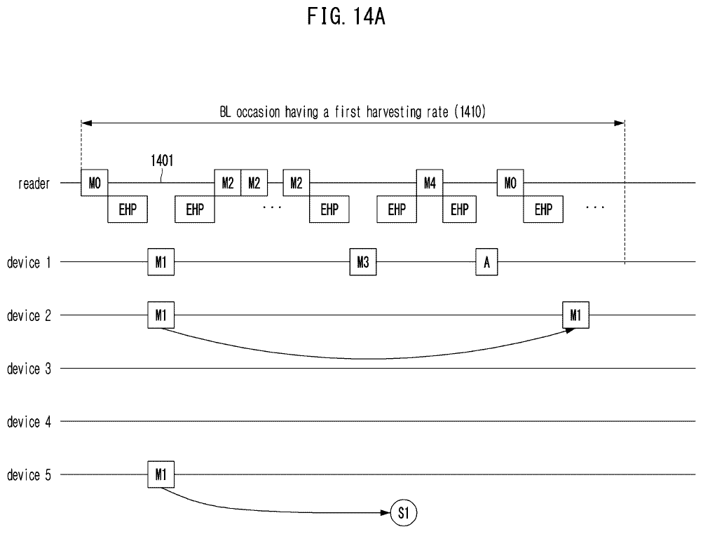

In response to reception of Msg3, the reader may generate a Msg4 (message 4) to be transmitted to the device(s) that transmitted Msg3. The reader may transmit the generated Msg4 to the device(s) through a PRDSCH. Accordingly, the device may receive the Msg4 transmitted by the reader through the PRDSCH. Hereinafter, a procedure in which the reader generates the Msg4 and transmits the Msg4 to the device is described with reference to FIG. 13.

FIG. 13 is a sequence diagram illustrating an operation in which a reader generates and transmits a Msg4 in an AIoT system.

In step S1300, the reader may configure information of a Msg4 to be transmitted to device(s). The Msg4 may be composed of information on the number N_{RA} of RA bits, a BL grant, other information, and a CRC code. The BL grant may include acknowledgement (ACK) information for the Msg3 received from device(s). In addition, the BL grant may further include information on a time and a modulation order (FDMA-based frequency allocation) through which the device is able to transmit additional data when additional BL transmission is required by the device.

In step S1302, the reader may scramble the generated Msg4 with the T_C-RNTI.

In step S1304, the reader may transmit the scrambled Msg4 to device(s) through a PRDSCH. In this case, the Msg4 may be transmitted consecutively to the PRDSB 926 as exemplified in FIG. 9C.

Device(s) may receive the Msg4 transmitted by the reader. By receiving the Msg4 from the reader, each device may identify whether the Msg3 transmitted by the device to the reader has been validly received by the reader or has not been received by the reader.

Thereafter, although not illustrated in FIG. 9C, each device may transmit acknowledgement for reception of the Msg4 to the reader. When each device transmits acknowledgement for the Msg4 to the reader, acknowledgement transmitted by each device may be transmitted to the reader by using the same format as the Gold sequence used when the device transmitted the Msg1 to the reader.

The procedures for Msg0 to Msg4 between the reader and the device described with reference to FIG. 9A to FIG. 9C and FIG. 10A, FIG. 10B, FIG. 11A, FIG. 11B, FIG. 12, and FIG. 13 may be understood as inquiry and inventory procedures between the reader and the device. The device that has successfully completed the procedures for Msg0 to Msg4 may transition to a sleep mode. Even when the device transitions to the sleep mode, the T_C-RNTI received from the reader may be stored for a certain period. When a storage period of the T_C-RNTI expires or when the device is discharged due to failure in charging, the T_C-RNTI may be deleted. Therefore, the procedures of FIG. 9A to FIG. 9C may be repeatedly performed whenever required or periodically by a request of the reader.

### [4]. Method for Setting a Back-Off Considering a Harvesting Rate of a Device

Hereinafter, a random access channel access method considering various capabilities of a device and an environment and/or a distance between the device and the reader is described.

When a large number of devices attempt random access, collisions between Msg1 transmitted by the devices may occur in a BL occasion. Therefore, in order to mitigate such collisions and indicate Msg1 retransmission to devices in which Msg1 collisions occur, the reader may transmit a maximum window value to devices as described above.

The maximum window value may be set in Msg0 for collision mitigation, or may be provided to devices in which Msg1 collisions occur for Msg1 retransmission by using Msg2. Devices may randomly perform back-off within the maximum window value included in Msg0 or Msg2 received from the reader.

As described with reference to FIG. 9A, the reader may transmit Msg0 to device(s). A device may receive Msg0 from the reader. The device may decode the Msg0 to obtain one or more of slot counter information or frame counter information. The device may transmit a Msg1 to the reader based on the Msg0, and the Msg1 may be scrambled with an RA-RNTI and transmitted to the reader. As described above, the RA-RNTI may be generated by including a random number randomly generated by the device. Accordingly, the device may store the random number generated by the device.

The reader may receive the Msg1 scrambled with the RA-RNTI, and may confirm reception of Msg1 based on various RA-RNTI combinations. When confirming reception of Msg1, the reader may transmit Msg2 to device(s) that transmitted Msg1. Accordingly, the device that transmitted Msg1 may receive Msg2 from the reader and may descramble the Msg2 with the RA-RNTI. The device may identify whether the received Msg2 is Msg2 for the device itself through a CRC code of the received Msg2. When the received Msg2 is not Msg2 for the device itself, the device may determine that transmission of Msg1 has failed.

When determining that transmission of Msg1 has failed, the device may perform random back-off within a range of the maximum window value received through the Msg0 or Msg2. In this case, a range in which random back-off is performed may be determined within the maximum window value according to a capability and/or a harvesting rate of the device.

In addition, distances between devices and the reader may be different from each other. In other words, a distance A1 between the reader and device A, a distance B1 between the reader and device B, and a distance C1 between the reader and device C may have different values. Accordingly, even when the reader transmits a signal with the same power in EHPs, energies harvested by device A, device B, and device C may be different from each other. When device A is located at a position very close to the reader compared to device B and device C, an energy harvesting rate of device A may be much higher than those of other devices. Accordingly, device A may be capable of BL transmission faster than other devices. When B1 has a value much larger than A1 and C1, in other words, when the distance between device B and the reader is much farther than the distance between device A and the reader and the distance between device C and the reader, a time required for device B to harvest energy for BL transmission may take a much longer time than device A and device C. In this case, a delay for BL transmission of device B may inevitably be long.

Accordingly, when performing an RACH procedure in the slotted ALOHA scheme described above, the present disclosure provides a channel access method based on a harvesting rate by performing random back-off with differently configured recommended time durations.

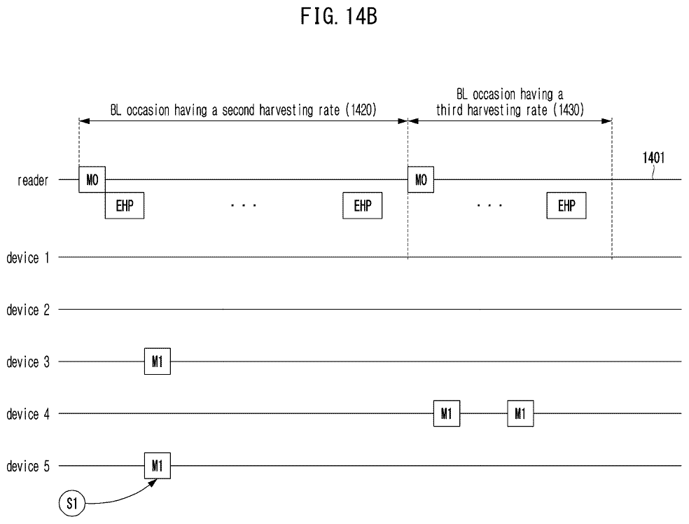

FIG. 14A is a partial timing diagram illustrating a procedure in which a back-off time is determined according to an energy harvesting rate of a device in an AIoT system, and FIG. 14B is a remaining timing diagram illustrating the procedure in which the back-off time is determined according to the energy harvesting rate of the device in an AIoT system.

FIG. 14A and FIG. 14B are timing diagrams of consecutive time. In FIG. 14A and FIG. 14B, one reader and five devices are exemplified. In FIG. 14A, the five devices have different device capabilities, and a distance between each device and the reader is also assumed to be different.

Meanwhile, as described above, the reader may transmit or broadcast to device(s) by including information on a ratio between EHPs and FL/BL periods in Msg0. A high ratio between EHPs and FL/BL periods may indicate that EHPs are transmitted more than the FL/BL transmission periods. On the other hand, a low ratio between EHPs and FL/BL periods may indicate a case in which a portion of EHPs is relatively small compared to FL/BL periods. A device may determine a period in which Msg1 is to be transmitted based on the ratio between EHPs and FL/BL periods included in Msg0. In the example illustrated in FIG. 14A and FIG. 14B, for convenience of description, three BL occasions may be configured based on the information on the ratio between EHPs and FL/BL periods. Configuration of three BL occasions based on the ratio between EHPs and FL/BL periods is merely one example for facilitating understanding of the present disclosure, and configuration of two or more BL occasions based on the ratio between EHPs and FL/BL periods may also be performed.

In FIG. 14A and FIG. 14B, a BL occasion 1410 having a first harvesting rate may correspond to a case in which four or more EHPs are included within the BL occasion 1410 based on a ratio between EHPs and FL/BL periods. A BL occasion 1420 having a second harvesting rate may correspond to a case in which fewer than four and two or more EHPs are included within the BL occasion 1420 based on a ratio between EHPs and FL/BL periods. A BL occasion 1430 having a third harvesting rate may correspond to a case in which one or more EHPs are included within the BL occasion 1430 based on a ratio between EHPs and FL/BL periods.

In FIG. 14A and FIG. 14B, it should be noted that the EHPs are exemplified below corresponding messages of the RACH procedure in order to reduce complexity of the drawing.

Based on such assumptions, a case in which a RACH procedure and back-off are performed is described with reference to FIG. 14A and FIG. 14B. In addition, in FIG. 14A and FIG. 14B, in order to reduce complexity of the drawing, Msg0 is denoted as “M0”, Msg1 is denoted as “M1”, Msg2 is denoted as “M2”, Msg3 is denoted as “M3”, and Msg4 is denoted as “M4”.

The reader may transmit an initial Msg0 within the BL occasion 1410 having the first harvesting rate. In addition, the reader may continuously transmit a carrier 1401. As described above, the Msg0 may include information on a ratio between EHPs and FL/BL periods. Each device may receive the Msg0 transmitted by the reader, and may identify that four or more EHPs are included within the BL occasion 1410 having the first harvesting rate based on the information on the ratio between EHPs and FL/BL periods included in the Msg0.

Each device may transmit a Msg1 to the reader using a backscattering scheme in the BL occasion 1410 having the first harvesting rate. FIG. 14A may be a drawing assuming a case in which device 1, device 2, and device 5 transmit Msg1 to the reader using the backscattering scheme.

As in the example of FIG. 14A, when multiple devices, for example, device 1, device 2, and device 5 transmit Msg1, a collision may occur among Msg1 transmitted by device 1, Msg1 transmitted by device 2, and Msg1 transmitted by device 5. When a collision of Msg1 occurs, the reader may fail to receive all Msg1 transmitted by the devices, or may normally receive only Msg1 received from one specific device and may fail to receive Msg1 transmitted by the remaining devices.

Since the reader cannot know which device transmits Msg1, as described above, the reader may check from which device Msg1 is received through various combinations. FIG. 14A may be an example assuming a case in which the reader receives Msg1 transmitted by device 1.

The reader may transmit a Msg2 to device 1 based on reception of the Msg1 from device 1 as described above. In addition, the reader may transmit the Msg2 for transmitting information on a BL period in which a next Msg1 can be transmitted to devices that transmitted Msg1 but from which the reader failed to receive Msg1. Since this has been described above, redundant description is omitted.

A procedure of device 1 that has received Msg2 responding to transmission of Msg1 is first described. Device 1 may transmit a Msg3 to the reader based on information included in Msg2, and may receive a Msg4 from the reader. Device 1 that receives the Msg4 may transmit acknowledgement (ACK) to the reader. In FIG. 14A, it should be noted that the acknowledgement is denoted as “A”.

Meanwhile, device 2 may be in a case in which device 2 transmitted Msg1 to the reader but fails to receive, from the reader, a Msg2 corresponding to the transmitted Msg1. Device 5 may also be in a case in which device 5 transmitted Msg1 to the reader but fails to receive a Msg2 corresponding to the Msg1 transmitted by device 5 from the reader.

Device 2 and device 5 may receive the Msg2 including information on a next BL occasion and a back-off maximum window value from the reader. Accordingly, device 2 and device 5 may perform random back-off. Device 2 and device 5 may each perform random back-off within a contention window. Random back-off may be determined by a counter value (i.e. q) indicating a random number. The counter value q indicating a random number may indicate a frame for which back-off is to be performed. A minimum value of the counter value q indicating a random number is zero, and may be determined as a contention window within a maximum value range. A maximum value of the counter value q indicating a random number may be expressed as in Equation 11 below.

CWmin×EHᵣₐₜₑ [Equation 11]

In Equation 12, CWₘᵢₙ may be a value arbitrarily set by the reader through estimation of the number of Msg1 collisions, and EHᵣₐₜₑ may be a value based on the energy harvesting rate described above. For example, in the BL occasion 1410 having the first energy harvesting rate, EHᵣₐₜₑ may be 4, in the BL occasion 1420 having the second energy harvesting rate, EHᵣₐₜₑ may be 2, and in the BL occasion 1430 having the third energy harvesting rate, EHᵣₐₜₑ may be 1.

Since CWmin in Equation 11 is a value arbitrarily set by the reader through estimation of the number of Msg1 collisions, the reader may provide an updated value to device(s) using the Msg2 or a subsequent Msg0 each time after receiving Msg1.

Device(s) that determine that transmission of Msg1 has failed, for example, device 2 and device 5, may set a contention window update value q based on a range of a counter value q indicating a random number as in Equation 12 below.

$$q = r a n d ( 0 , CW min \times ( 1 + CD ) / {EH}_{r a t e} ) \qquad [ Equation 12 ]$$

In Equation 12, CD indicates the number of collisions, and an initial value thereof may be zero. When a device fails to receive Msg2 or when no Msg2 received for the device exists among a plurality of Msg2 transmitted by the reader, the device may increase CD.

Each device may drive a counter set to a contention window update value as in Equation 12 when failing to receive Msg2 corresponding to Msg1 transmitted by the device. Each device may transmit Msg1 in a BL period when a counter value set as the contention window update value becomes zero. In other words, each device does not attempt transmission of Msg1 in a BL period until the counter value set as the contention window update value becomes zero.

According to the example of FIG. 14A, device 2 may be in a case in which a contention window update value is set to transmit Msg1 when a next Msg0 is received. On the other hand, a contention window update value set for device 5 may be in a case in which Msg1 responding to Msg0 cannot be transmitted within the BL occasion 1410 having the first harvesting rate.

Referring to FIG. 14B configured with time consecutive to FIG. 14A, a case is exemplified in which device 5 transmits Msg1 to the reader using a backscattering scheme based on the Msg0 transmitted by the reader in the BL occasion 1420 having the second harvesting rate. In addition, at the same time, device 3 may transmit Msg1 to the reader using the backscattering scheme.

As described above, the BL occasion 1420 having the second harvesting rate may correspond a period having fewer EHPs compared to the BL occasion 1410 having the first harvesting rate.

In FIG. 14B, a case configured with the BL occasion 1430 having the third harvesting rate after the BL occasion 1420 having the second harvesting rate is exemplified. A case in which device 4 transmits Msg1 to the reader using a backscattering scheme in the BL occasion 1430 having the third harvesting rate is exemplified.

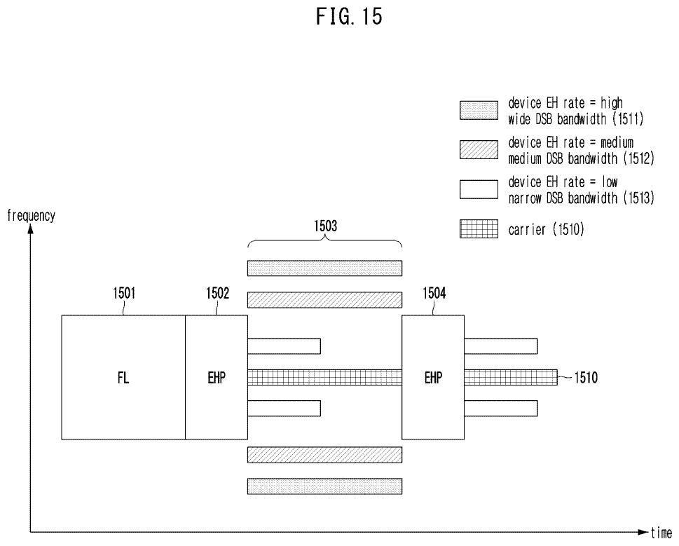

Meanwhile, in addition to a method of applying a temporal back-off counter, distribution regarding selection of a frequency resource in which Msg1 is transmitted may be considered according to energy harvesting rate capability of each device. A method of selecting a frequency resource in which Msg1 is transmitted according to energy harvesting rate capability of a device is described with reference to FIG. 15.

FIG. 15 is a conceptual diagram illustrating selection of a frequency resource in which a Msg1 is transmitted according to energy harvesting rate capability of a device.

Referring to FIG. 15, an FL period 1501, an EHP 1502, a BL period 1503, and an EHP 1504 are exemplified in a temporal manner.

In the FL period 1501, the reader may perform FL transmission to devices. In addition, in the EHP 502, the reader may broadcast a signal for supplying energy to device(s), and each of the devices may harvest and store energy using the signal transmitted by the reader in the EHP 1502. In FIG. 15, the FL period 1501 is exemplified as having the same band as the EHP 1502 on a frequency axis. However, it should be noted that the FL period may have a narrower frequency band than the EHP 1502 based on an amount of data to be transmitted and a transmission rate.

When an energy harvesting rate is high, the device may estimate that an input signal power of a backscattering carrier wave (CW) is relatively high, compared to a case in which the energy harvesting rate is low. In addition, when the distance between the device and the reader is short, the device may estimate that the input signal power of the backscattering carrier wave is relatively high, compared to a case in which the distance between the device and the reader is long. Furthermore, when a Signal-to-Interference-plus-Noise Ratio (SINR) of a forward link (FL) reception signal from the reader to the device is high, the device may infer that a backscatter link (BL) reception SINR from the device to the reader is also high.

Accordingly, transmission of a signal having a high data rate by a device having a high energy harvesting rate may be more suitable than transmission of a signal having a high data rate by a device having a low energy harvesting rate. Here, a high data rate may indicate a high baseband sampling rate or a high modulation order (e.g. OOK-4).

A device having a high energy harvesting rate (e.g. EHᵣₐₜₑ=4) may support an increased data rate even when using the BPSK modulation scheme. When the data rate of the BPSK modulation scheme is increased, BL transmission may be performed by widening a bandwidth around a baseband carrier, or by employing a high dual sideband (DSB) or single sideband (SSB) square-wave amplitude modulation (AM) scheme in which little or no signal power exists around the carrier frequency. Since the carrier serves as a reference frequency, the carrier component may correspond to a direct current (DC) component in the frequency domain.

Accordingly, a device having a high energy harvesting rate (e.g. EHᵣₐₜₑ=4) may be understood as being capable of utilizing a relatively wide frequency deviation with respect to a carrier frequency. In FIG. 15, the carrier 1510 may be regarded as a reference frequency corresponding to a DC component, and a frequency resource allocated to the device having the high energy harvesting rate (e.g. EHᵣₐₜₑ=4) may include a wide dual sideband (DSB) bandwidth 1511. In the case of amplitude modulation (AM) using DSB, the device having the high energy harvesting rate may utilize frequency components on both sides of the carrier 1510, whereas in the case of AM using single sideband (SSB), the device may utilize frequency components on only one side of the carrier 1510.

On the other hand, a device located far from the reader or a device having a low energy harvesting rate (e.g. EHᵣₐₜₑ=1) may support only a relatively low data rate, and thus may be allocated a narrow DSB bandwidth 1513.

Accordingly, when energy harvesting rates are classified into three levels, a device having an intermediate accumulated energy harvesting rate (e.g. EHᵣₐₜₑ=2) may be allocated an intermediate DSB bandwidth 1512.

Based on the description provided with reference to FIG. 15, an energy harvesting rate (EHᵣₐₜₑ) may be interpreted as corresponding to a modulation order. In other words, when transmitting Msg1 or Msg3, a device may select a modulation order based on its energy harvesting rate.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a device, comprising:
receiving, from a reader, a message 0 (Msg0) indicating initiation of a random access procedure;
transmitting, to the reader, a message 1 (Msg1) for random access based on information included in the Msg0 by using a backscattering scheme;
receiving, from the reader, a plurality of messages 2 (Msg2);
based on existence of a first Msg2 among the plurality of Msg2 that responds to the Msg1, transmitting, to the reader, a message 3 (Msg3) including information of the device based on first information included in the first Msg2 by using the backscattering scheme; and
receiving, from the reader, a message 4 (Msg4) responding to the Msg3,
wherein the Msg0 includes at least one of information on a counter of at least one of a slot or a frame, information on a ratio of energy harvesting periods (EHPs) within a predetermined time duration, information on a minimum awake duration of the device, command type information, or backward link (BL) occasion resource information.

2. The method of claim 1, wherein the Msg0 is transmitted by being scrambled with a scrambling bit sequence generated based on a forward link (FL) start indicator sequence (SIS).

3. The method of claim 1, wherein the Msg1 is transmitted to the reader in a BL occasion based on the BL occasion resource information included in the Msg0 by using the backscattering scheme, and the Msg1 is generated using a bit sequence based on a number of a slot or frame in which the Msg1 is transmitted and a value randomly generated by the device.

4. The method of claim 1, wherein a second Msg2 among the plurality of Msg2 includes second information for notifying devices that have failed Msg1 transmission, and the second information includes information on a next BL occasion and a maximum back-off window value for Msg1 transmission.

5. The method of claim 1, wherein the first information includes at least one of frequency division multiple access (FDMA)-based frequency resource allocation information for transmission of the Msg3, information on a slot or frame for transmission of the Msg3, or information on a modulation order for data included in the Msg3.

6. The method of claim 1, wherein the Msg3 is modulated with a second modulation order higher than a first modulation order used for transmission of the Msg1, based on at least one of an energy harvesting rate of the device or a ratio of EHPs within a predetermined time duration being equal to or greater than a preset first value.

7. The method of claim 1, further comprising: transmitting, to the reader, acknowledgement (ACK) information in response to reception of the Msg4 by using the backscattering scheme.

8. A method of a reader, comprising:
transmitting, to devices, in a forward link (FL), a message 0 (Msg0) indicating initiation of a random access procedure;
receiving, from the devices, a plurality of messages 1 (Msg1) for random access based on information included in the Msg0;
generating a plurality of first messages 2 (Msg2) including first information to be transmitted to first devices from which reception of the Msg1 has succeeded, and a second Msg2 including second information to be transmitted to second devices from which reception of the Msg1 has failed;
transmitting the plurality of first Msg2 and the second Msg2 to the devices by time-division multiplexing;
receiving, from each of one or more of the first devices, a message 3 (Msg3) including information of each of one or more of the first devices based on the first Msg2; and
transmitting a message 4 (Msg4) responding to the Msg3 to the one or more of the first devices,
wherein the Msg0 includes at least one of information on a counter of at least one of a slot or a frame, information on a ratio of energy harvesting periods (EHPs) within a predetermined time duration, information on a minimum awake duration of the devices, command type information, or backward link (BL) occasion resource information.

9. The method of claim 8, wherein the Msg0 is transmitted by being scrambled with a scrambling bit sequence generated based on an FL start indicator sequence (SIS).

10. The method of claim 8, wherein the Msg1 is generated using a bit sequence based on a number of a slot or frame in which the Msg1 is transmitted and a value randomly generated by the device.

11. The method of claim 8, wherein the second information includes information on a next BL occasion and a maximum back-off window value for Msg1 transmission.

12. The method of claim 8, wherein the first information includes at least one of frequency division multiple access (FDMA)-based frequency resource allocation information for transmission of the Msg3, information on a slot or frame for transmission of the Msg3, or information on a modulation order for data included in the Msg3.

13. The method of claim 8, wherein the Msg3 is modulated with a second modulation order higher than a first modulation order used for transmission of the Msg1, based on at least one of an energy harvesting rate of the device or a ratio of EHPs within a predetermined time duration being equal to or greater than a preset first value.

14. The method of claim 8, further comprising: receiving, from the one or more of the first devices, acknowledgement (ACK) information in response to transmission of the Msg4.

15. A device comprising at least one processor, wherein the at least one processor causes the device to perform:
receiving, from a reader, a message 0 (Msg0) indicating initiation of a random access procedure;
transmitting, to the reader, a message 1 (Msg1) for random access based on information included in the Msg0 by using a backscattering scheme;
receiving, from the reader, a plurality of messages 2 (Msg2);
based on existence of a first Msg2 among the plurality of Msg2 that responds to the Msg1, transmitting, to the reader, a message 3 (Msg3) including information of the device based on first information included in the first Msg2 by using the backscattering scheme; and
receiving, from the reader, a message 4 (Msg4) responding to the Msg3,
wherein the Msg0 includes at least one of information on a counter of at least one of a slot or a frame, information on a ratio of energy harvesting periods (EHPs) within a predetermined time duration, information on a minimum awake duration of the device, command type information, or backward link (BL) occasion resource information.

16. The device of claim 15, wherein the Msg0 is transmitted by being scrambled with a scrambling bit sequence generated based on a forward link (FL) start indicator sequence (SIS).

17. The device of claim 15, wherein the Msg1 is transmitted to the reader in a BL occasion based on the BL occasion resource information included in the Msg0 by using the backscattering scheme, and the Msg1 is generated using a bit sequence based on a number of a slot or frame in which the Msg1 is transmitted and a value randomly generated by the device.

18. The device of claim 15, wherein a second Msg2 among the plurality of Msg2 includes second information for notifying devices that have failed Msg1 transmission, and the second information includes information on a next BL occasion and a maximum back-off window value for Msg1 transmission.

19. The device of claim 15, wherein the first information includes at least one of frequency division multiple access (FDMA)-based frequency resource allocation information for transmission of the Msg3, information on a slot or frame for transmission of the Msg3, or information on a modulation order for data included in the Msg3.

20. The device of claim 15, wherein the Msg3 is modulated with a second modulation order higher than a first modulation order used for transmission of the Msg1, based on at least one of an energy harvesting rate of the device or a ratio of EHPs within a predetermined time duration being equal to or greater than a preset first value.
